(19) United States
(12) Patent Application Publication
(10) Pub. No.: US 2013/0050854 A1
(43) Pub. Date: Feb. 28, 2013

(54) LENS BARREL AND IMAGING APPARATUS

(71) Applicants: RYUHEI AZUMA, Kanagawa (JP); YOSHINORI MUTO, Kanagawa (JP); TAKUYA TSUTSUMI, Tokyo (JP); TAKAFUMI KAWASAKI, Tokyo (JP); FUMIYOSHI ITOU, Kanagawa (JP); HAJIME NAKAMURA, Tokyo (JP); DAISUKE KURODA, Kanagawa (JP); KENJI ISHIDA, Tokyo (JP)

(72) Inventors: RYUHEI AZUMA, Kanagawa (JP); YOSHINORI MUTO, Kanagawa (JP); TAKUYA TSUTSUMI, Tokyo (JP); TAKAFUMI KAWASAKI, Tokyo (JP); FUMIYOSHI ITOU, Kanagawa (JP); HAJIME NAKAMURA, Tokyo (JP); DAISUKE KURODA, Kanagawa (JP); KENJI ISHIDA, Tokyo (JP)

(73) Assignee: Sony Corporation, Tokyo (JP)

(21) Appl. No.: 13/592,557

(22) Filed: Aug. 23, 2012

(30) Foreign Application Priority Data
Aug. 30, 2011 (JP) 2011-187927

(51) Int. Cl. G02B 7/02

(52) U.S. Cl. 359/819

(57) ABSTRACT

Disclosed herein is a lens barrel, including: plural barrel cases having holding frame portions holding optical members, respectively, and coupled to one another in a predetermined direction; and plural abutment portions made to abut against one another in a state in which the plural barrel cases are coupled to the holding frame portions, respectively, wherein the abutment portion of at least one of the plural barrel cases coupled to one another is formed in a shape protruding to the abutment portion side of the other of the plural barrel cases coupled to one another.

### BACKGROUND

The present disclosure relates to a lens barrel and an imaging apparatus including the same. More particularly, the present disclosure relates to a lens barrel in which abutment portions which are made to abut against one another are provided in barrel cases coupled to one another, thereby preventing generation of deformation and strain in a state in which the barrel cases are coupled to one another, and an imaging apparatus including the same.

In some of various kinds of imaging apparatuses such as a video camera, a barrel case and a lens barrel having predetermined optical members held by the barrel case are disposed. In this case, the predetermined optical members, for example, includes a lens, a light blocking plate, a diaphragm, an iris, a shutter, an optical filter, and an imaging element. With the imaging apparatus, an image of a subject is captured through the optical member such as the lens, and an optical image thus captured is then converted into an electrical signal, thereby carrying out the photographing.

In some of such imaging apparatuses, plural barrel cases are disposed which hold the optical members as described above, respectively. This sort of imaging apparatus, for example, is described in Japanese Patent Laid-Open No. 2010-26007.

The imaging apparatus described in Japanese Patent Laid-Open No. 2010-26007 is a so-called folded optical system apparatus in which an optical path is folded at a right angle, and three barrel cases are coupled to one another in order along the optical path. In such a folded optical system imaging apparatus, a coupling direction of three barrel cases is made a direction orthogonal to a direction in which a subject and a photographer are connected to each other, thereby making it possible to realize the thinning in a front-back direction as the direction in which the subject and the photographer are connected to each other.

### SUMMARY

However, in the imaging apparatus described in Japanese Patent Laid-Open No. 2010-26007, plural barrel cases are coupled to one another, thereby constructing the lens barrels. For this reason, the imaging apparatus described in Japanese Patent Laid-Open No. 2010-26007 involves a problem that deformation and strain become easy to generate all the more because a length in the coupling direction of the plural barrel cases of the lens barrels has a tendency to become long.

In addition, a degree of the deformation and strain as described above disperses among products even in the same kind of product. Thus, it is feared that a dispersion of optical resolution performances is generated among the products due to a difference in the degree of the deformation and strain generated.

In particular, in the folded optical system imaging apparatus, positional precision between a lens group held by the predetermined barrel case, and the barrel cases held by other barrel cases exerts a large influence on the optical performance. Thus, a request for ensuring a satisfactory coupling state among the barrel cases is high.

The present disclosure has been made in order to solve the problems described above, and it is therefore desirable to provide a lens barrel in which deformation and strain can be prevented from being generated in a state in which barrel cases are coupled to one another, and an imaging apparatus including the same.

In order to attain the desire described above, in the first place, according to an embodiment of the present disclosure, there is provided a lens barrel including: plural barrel cases having holding frame portions holding optical members, respectively, and coupled to one another in a predetermined direction; and plural abutment portions made to abut against one another in a state in which the plural barrel cases are coupled to the holding frame portions, respectively, in which the abutment portion of at least one of the plural barrel cases coupled to one another is formed in a shape protruding to the abutment portion side of the other of the plural barrel cases coupled to one another.

Therefore, in the lens barrel according to the embodiment of the present disclosure, in a state in which the plural barrel cases are coupled to one another, the abutment portions at least one of which is formed in the protruding shape are made to come in contact with each other.

Preferably, in the second place, in the lens barrel described above, the abutment portions which are made to abut against each other are formed in shapes protruding to sides of the abutment portions each receiving the abutment.

The abutment portions which are made to abut against each other are formed in the shapes protruding to the sides of the abutment portions each receiving the abutment, whereby in the state in which the plural barrel cases are coupled to one another, any of other portions other than other abutment portions is hard to come in contact with any of the abutment portions.

Preferably, in the third place, in the lens barrel described above, at least three abutment portions are provided in the holding frame portions.

The at least three abutment portions are provided in the holding frame portions, whereby in the state in which the plural barrel cases are coupled to one another, three or more abutment portions are made to come in contact with one another.

Preferably, in the fourth place, in the lens barrel described above, at least three barrel cases are coupled to one another in the predetermined direction, and the abutment portions provided in the barrel cases, respectively, and made to abut against one another are provided in positions, respectively, arranged on one straight lines in a coupling direction of the barrel cases.

The at least three barrel cases are coupled to one another in the predetermined direction, and the abutment portions provided in the barrel cases, respectively, and made to abut against one another are provided in the positions, respectively, arranged on one straight lines in the coupling direction of the barrel cases, whereby in the state in which the plural barrel cases are coupled to one another, the abutment portions are made to come in contact with one another on one straight lines.

Preferably, in the fifth place, in the lens barrel described above, plane-like abutment surfaces which are made to come in surface-contact with one another are formed in the abutment portions, respectively.

The plane-like abutment surfaces which are made to come in surface-contact with one another are formed in the abutment portions, respectively, whereby in the state in which the plural barrel cases are coupled to one another, the abutment portions are made to come in surface contact with one another.

Preferably, in the sixth place, in the lens barrel described above, each of portions of the holding frame portions in which the abutment portions are provided is provided as a thick portion which is thicker in a direction orthogonal to the coupling direction of the barrel cases than any of other portions of the holding frame portion.

Each of the portions of the holding frame portions in which the abutment portions are provided is provided as the thick portion which is thicker in the direction orthogonal to the coupling direction of the barrel cases than any of other portions of the holding frame portion, whereby each of the abutment portions is provided in a portion having high rigidity.

Preferably, in the seventh place, in the lens barrel described above, screw fastening portions in which the barrel cases coupled to one another are fastened by using mounting screws are provided in outer peripheral portions of the holding frame portion of the barrel case.

The screw fastening portions in which the barrel cases coupled to one another are fastened by using the mounting screws are provided in the outer peripheral portions of the holding frame portion of the barrel case, whereby in the state in which the plural barrel cases are coupled to one another, a force in a direction in which the abutment portions are made to come in contact with one another is easy to generate.

Preferably, in the eighth place, in the lens barrel described above, in the state in which the barrel cases are coupled to one another, the screw-fastening portions are held in a non-contact state.

In the state in which the barrel cases are coupled to one another, the screw-fastening portions are held in the non-contact state, whereby in the state in which the barrel cases are coupled to one another, the abutment portions are in close contact with one another.

Preferably, in the ninth place, in the lens barrel described above, a falling prevention protruding portion which is provided inside a chassis of an imaging apparatus, which is adapted to contact an inner surface of the chassis of the imaging apparatus, and which protrudes to the inner surface side of the chassis is provided in the barrel case.

The falling prevention protruding portion which is provided inside the chassis of the imaging apparatus, which is adapted to contact the inner surface of the chassis of the imaging apparatus, and which protrudes to the inner surface side of the chassis is provided in the barrel case, whereby when a force is applied to the lens barrel based on an external force, the falling prevention protruding portion can be made to contact the inner surface of the chassis.

Preferably, in the tenth place, in the lens barrel described above, the falling prevention protruding portion is located so as to face a reception protruding portion which is provided in the inner surface of the chassis so as to protrude to a side of the falling prevention protruding portion.

The falling prevention protruding portion is located so as to face the reception protruding portion which is provided in the inner surface of the chassis so as to protrude to the side of the falling prevention protruding portion, whereby when a force is applied to the lens barrel based on an external force, the falling prevention protruding portion can be made to contact the reception protruding portion.

Preferably, in the eleventh place, in the lens barrel described above, an inclination prevention protruding portion is provided in a surface on a side opposite to a surface on which the falling prevention protruding portion of the barrel case is provided.

The inclination prevention protruding portion is provided in the surface on the side opposite to the surface on which the falling prevention protruding portion of the barrel case is provided, whereby when a force is applied to the lens barrel based on an external force, the inclination prevention protruding portion can be made to contact either the chassis or another portion.

Preferably, in the twelfth place, in the lens barrel described above, the falling prevention protruding portion and the inclination prevention protruding portion are provided in positions, respectively, arranged on one straight line in the direction orthogonal to the coupling direction.

The falling prevention protruding portion and the inclination prevention protruding portion are provided in the positions, respectively, arranged on one straight line in the direction orthogonal to the coupling direction, whereby in the state in which the plural barrel cases are coupled to one another, both of the falling prevention protruding portion and the inclination prevention protruding portion can be made to contact either the chassis or another portion on one straight line.

Preferably, in the thirteenth place, in the lens barrel described above, three barrel cases are coupled to one another, and an interval between the falling prevention protruding portion of the barrel case located at a center, and the inner surface of the chassis is made smaller than that between the falling prevention protruding portion of each of other barrel cases, and the inner surface of the chassis.

Three barrel cases are coupled to one another, and the interval between the falling prevention protruding portion of the barrel case located at the center, and the inner surface of the chassis is made smaller than that between the falling prevention protruding portion of each of other barrel cases, and the inner surface of the chassis, whereby of the lens barrels, the falling prevention protruding portion of the barrel case located at the center in which in a phase of generation of the external force, the deformation is easy to most generate becomes easy to more come in contact with the inner surface of the chassis.

Preferably, in the fourteenth place, in the lens barrel described above, three barrel cases are coupled to one another, and an interval between the inclination prevention protruding portion of the barrel case located at the center, and the inner surface of the chassis is made smaller than that between the inclination prevention protruding portion of each of other barrel cases, and the inner surface of the chassis.

Three barrel cases are coupled to one another, and the interval between the inclination prevention protruding portion of the barrel case located at the center, and the inner surface of the chassis is made smaller than that between the inclination prevention protruding portion of each of other barrel cases, and the inner surface of the chassis, whereby of the lens barrels, the inclination prevention protruding portion of the barrel case located at the center in which in a phase of generation of the external force, the deformation is easy to most generate becomes easy to more come in contact with the inner surface of the chassis.

In the fifteenth place, according to another embodiment of the present disclosure, there is provided an imaging apparatus including: a chassis; and a lens barrel disposed inside the chassis, having a predetermined optical member, and capturing an optical image through the predetermined optical member, the lens barrel including: plural barrel cases having holding frame portions holding optical members, respectively, and coupled to one another in a predetermined direction; and plural abutment portions made to abut against one another in a state in which the plural barrel cases are coupled to the holding frame portions, respectively, in which the abutment portion of at least one of the plural barrel cases coupled to one another is formed in a shape protruding to the abutment portion side of the other of the plural barrel cases coupled to one another.

Therefore, in the imaging apparatus of another embodiment of the present disclosure, in the state in which the plural barrel cases are coupled to one another, the abutment portions at least one of which is formed in the protruding shape come in contact with one another.

In the first place, according to the embodiment of the present invention, the lens barrel includes; the plural barrel cases having the holding frame portions holding optical members, respectively, and coupled to one another in the predetermined direction; and the plural abutment portions made to abut against one another in the state in which the plural barrel cases are coupled to the holding frame portions, respectively, in which the abutment portion of at least one of the plural barrel cases coupled to one another is formed in the shape protruding to the abutment portion side of the other of the plural barrel cases coupled to one another.

Therefore, in the state in which the plural barrel cases are coupled to one another, the abutment portions at least one of which is formed in the protruding shape are made to come in contact with each other. Thus, in the state in which the plural barrel cases are coupled to one another, it is possible to prevent the generation of the deformation and the strain in the lens barrel.

In the second place, in the lens barrel described above, the abutment portions which are made to abut against each other are formed in the shapes protruding to the sides of the abutment portions each receiving the abutment.

Therefore, the satisfactory contact state between the abutment portions can be ensured, and thus the generation of the deformation and the strain in the lens barrel can be further prevented.

In the third place, in the lens barrel described above, the at least three abutment portions are provided in the holding frame portions.

Therefore, the stable coupling state among the plural barrel cases can be ensured, and thus the generation of the deformation and the strain in the lens barrel can be further prevented.

In the fourth place, in the lens barrel described above, the at least three barrel cases are coupled to one another in the predetermined direction, and the abutment portions provided in the barrel cases, respectively, and made to abut against one another are provided in the positions, respectively, arranged on one straight lines in the coupling direction of the barrel cases.

Therefore, the stable coupling state among the plural barrel cases can be ensured, and the generation of the deformation and the strain in the state in which the plural barrel cases are coupled to one another can be prevented.

In the fifth place, in the lens barrel described above, the plane-like abutment surfaces which are made to come in surface-contact with one another are formed in the abutment portions, respectively.

Therefore, the abutment portions are made to come in surface-contact with each other, and thus the generation of the deformation and the strain in the lens barrel can be more effectively prevented.

In the sixth place, in the lens barrel described above, each of the portions of the holding frame portions in which the abutment portions are provided is provided as the thick portion which is thicker in the direction orthogonal to the coupling direction of the barrel cases than any of other portions of the holding frame portion.

Therefore, the abutment portions each provided in the portion having the high rigidity as the thick portion are made to abut against each other. Thus, the strength in the state in which the lens barrel is assembled is high, and thus the generation of the deformation and the strain can be effectively prevented.

In the seventh place, in the lens barrel described above, the screw fastening portions in which the barrel cases coupled to one another are fastened by using the mounting screws are provided in the outer peripheral portions of the holding frame portion of the barrel case.

Therefore, since a force in a direction in which the abutment portions provided in the holding frame portions, respectively, by using the mounting screws come close to each other is easy to generate, the abutment portions can be made to reliably contact each other.

In the eighth place, in the lens barrel described above, in the state in which the barrel cases are coupled to one another, the screw-fastening portions are held in a non-contact state.

Therefore, the abutment portions provided in the holding frame portions, respectively, by using the mounting screws are made to come in close contact with each other, and thus the satisfactory contact stare between the abutment portions can be ensured.

In the ninth place, in the lens barrel described above, the falling prevention protruding portion which is provided inside the chassis of the imaging apparatus, which is adapted to contact the inner surface of the chassis of the imaging apparatus, and which protrudes to the inner surface side of the chassis is provided in the barrel case.

Therefore, when the force applied to the lens barrel based on the external force, the falling prevention protruding portion can be made to come in contact with the internal surface of the chassis, and thus the generation of the deformation and the strain due to the external force can be prevented.

In the tenth place, in the lens barrel described above, the falling prevention protruding portion is located so as to face the reception protruding portion which is provided in the inner surface of the chassis so as to protrude to the side of the falling prevention protruding portion.

Therefore, when the force is applied to the lens barrel based on the external force, the falling prevention protruding portion can be made to come in contact with the reception protruding portion. In this case, the rigidity of the chassis is made higher by the reception protruding portion, and thus the generation of the deformation and the strain in the lens barrel when the external force is generated can be prevented.

In the eleventh place, in the lens barrel described above, the inclination prevention protruding portion is provided in the surface on the side opposite to the surface on which the falling prevention protruding portion of the barrel case is provided.

Therefore, when the force is applied to the lens barrel based on the external force, the inclination prevention protruding portion can be made to come in contact with either the chassis or another portion, and thus the deformation and the strain in the lens barrel due to the external force can be prevented.

In the twelfth place, in the lend barrel described above, the falling prevention protruding portion and the inclination prevention protruding portion are provided in the positions, respectively, arranged on one straight line in a direction orthogonal to the coupling direction.

Therefore, the effect of preventing the generation of the deformation and the strain in the lens barrel due to the external force can be enhanced by both of the falling prevention protruding portion and the inclination prevention protruding portion.

In the thirteenth place, in the lens barrel described above, three barrel cases are coupled to one another, and the interval between the falling prevention protruding portion of the barrel case located at a center, and the inner surface of the chassis is made smaller than that between the falling prevention protruding portion of each of other barrel cases, and the inner surface of the chassis.

Therefore, since of the lens barrels, the falling prevention protruding portion of the barrel case located at the center in which in a phase of generation of the external force, the deformation is easy to most generate becomes easy to most come in contact with the inner surface of the chassis, the deformation and the strain in the lens barrel can be effectively prevented.

In the fourteenth place, in the lens barrel described above, three barrel cases are coupled to one another, and the interval between the inclination prevention protruding portion of the barrel case located at the center, and the inner surface of the chassis is made smaller than that between the inclination prevention protruding portion of each of other barrel cases, and the inner surface of the chassis.

Therefore, of the lens barrels, the inclination prevention protruding portion of the barrel case located at the center in which in a phase of generation of the external force, the deformation is easy to most generate becomes easy to more come in contact with either the chassis or another portion, the deformation and the strain in the lens barrel can be effectively prevented.

In the fifteenth place, according to another embodiment of the present disclosure, the imaging apparatus includes: the chassis; and the lens barrel disposed inside the chassis, having the predetermined optical member, and capturing the optical image through the predetermined optical member, the lens barrel including: the plural barrel cases having the holding frame portions holding the optical members, respectively, and coupled to one another in the predetermined direction; and the plural abutment portions made to abut against one another in the state in which the plural barrel cases are coupled to the holding frame portions, respectively, in which the abutment portion of the at least one of the plural barrel cases coupled to one another is formed in the shape protruding to the abutment portion side of the other of the plural barrel cases coupled to one another.

Therefore, in the state in which the plural barrel cases are coupled to one another, the abutment portions at least one of which is formed in the protruding shape come in contact with each other. Thus, in the state in which the plural barrel cases are coupled to one another, the generation of the deformation and the strain in the lens barrel can be prevented.

### BRIEF DESCRIPTION OF THE DRAWINGS

FIG. 1 is an enlarged perspective view mainly showing a construction of a front surface side of a lens barrel according to a first embodiment of the present disclosure;

FIG. 2 is an enlarged perspective view mainly showing a construction of a back surface side of the lens barrel according to the first embodiment of the present disclosure;

FIG. 3 is an exploded perspective view mainly showing the construction of the front surface side of the lens barrel according to the first embodiment of the present disclosure;

FIG. 4 is an exploded perspective view mainly showing the construction of the back surface side of the lens barrel according to the first embodiment of the present disclosure;

FIG. 5 is an enlarged perspective view mainly showing a construction of a front surface side of a first barrel case of the lens barrel of the first embodiment;

FIG. 6 is an enlarged perspective view mainly showing a construction of a back surface side of the first barrel case of the lens barrel of the first embodiment;

FIG. 7 is an enlarged perspective view mainly showing a construction of an upper surface side of the first barrel case of the lens barrel of the first embodiment;

FIG. 8 is an enlarged perspective view mainly showing a construction of a front surface side of a second barrel case of the lens barrel of the first embodiment;

FIG. 9 is an enlarged perspective view mainly showing a construction of a back surface side of the second barrel case of the lens barrel of the first embodiment;

FIG. 10 is an enlarged perspective view mainly showing a construction of an upper surface side of the second barrel case of the lens barrel of the first embodiment;

FIG. 11 is an enlarged perspective view mainly showing a construction of a lower surface side of the second barrel case of the lens barrel of the first embodiment;

FIG. 12 is an enlarged perspective view mainly showing a construction of a front surface side of a third barrel case of the lens barrel of the first embodiment;

FIG. 13 is an enlarged perspective view mainly showing a construction of a back surface side of the third barrel case of the lens barrel of the first embodiment;

FIG. 14 is an enlarged perspective view mainly showing a construction of an upper surface side of the third barrel case of the lens barrel of the first embodiment;

FIG. 15 is an enlarged perspective view showing a construction of a zoom movement frame of the lens barrel of the first embodiment;

FIG. 16 is an enlarged perspective view showing a construction of a focus movement frame of the lens barrel of the first embodiment;

FIG. 17 is a conceptual view showing a lens construction and the like of the lens barrel of the first embodiment;

FIG. 18 is an enlarged exploded perspective view showing a construction of the first barrel case and the second barrel case;

FIG. 19 is a schematically enlarged cross sectional view showing a state in which the first barrel case and the second barrel case are coupled to each other;

FIG. 20 is an enlarged exploded perspective view showing a construction of the second barrel case and the third barrel case;

FIG. 21 is a schematically enlarged cross sectional view showing a state in which the second barrel case and the third barrel case are coupled to each other;

FIG. 22 is a schematically enlarged cross sectional view showing a construction in a state in which the first barrel case, the second barrel case, and the third barrel case are coupled to one another;

FIG. 23 is a schematically enlarged cross sectional view showing a construction in a state in which the first barrel case, the second barrel case, and the third barrel case are coupled to one another, and are fixed by mounting screws;

FIG. 24 is a conceptual view showing a positional relationship and the like between a chassis, and falling prevention protruding portions and inclination prevention protruding portions of the lens barrel of the first embodiment;

FIG. 25 is a conceptual view showing another positional relationship and the like between the chassis, and the falling prevention protruding portions and the inclination prevention protruding portions of the lens barrel of the first embodiment;

FIG. 26 is a conceptual view showing still another positional relationship and the like between the chassis, and the falling prevention protruding portions and the inclination prevention protruding portions of the lens barrel of the first embodiment;

FIG. 27 is a conceptual view showing the case where three abutment portions are provided;

FIG. 28 is a conceptual view showing the case where two abutment portions are provided;

FIG. 29 is a conceptual view showing the case where one of the abutment portions is formed in a protruding shape;

FIG. 30 is a conceptual view showing the case where an external surface of one of the abutment portions is formed in a curved surface-like shape;

FIG. 31 is a perspective view showing a construction of an imaging apparatus according to a second embodiment of the present disclosure in a state in which an opening-closing cover is closed;

FIG. 32 is a perspective view showing a construction of the imaging apparatus according to the second embodiment of the present disclosure in a state in which the opening-closing cover is opened;

FIG. 33 is a back view of the imaging apparatus shown in FIGS. 31 and 32; and

FIG. 34 is a block diagram showing a configuration of the imaging apparatus according to the second embodiment of the present disclosure.

### DETAILED DESCRIPTION OF THE PREFERRED EMBODIMENTS

Embodiments of the present disclosure will be described in detail hereinafter with reference to the accompanying drawings.

An imaging apparatus of the present disclosure is applied to a still camera, and a lens barrel of the present disclosure is applied to a lens barrel provided in the still camera. It is noted that the scope of application of the present disclosure is by no means limited to the still camera and the lens barrel provided in the still camera. The present disclosure, for example, can be generally applied to various kinds of imaging apparatuses such as cameras which are incorporated in other apparatuses such as a video camera and a mobile phone, and various kinds of lens barrels provided in the various kinds of imaging apparatuses.

In the following description, a front-back direction, a vertical direction or a horizontal direction when viewed from an observer in a phase of photographing carried out by using the still camera will be shown. Therefore, a side of a subject becomes the front side, and a side of the observer becomes the back side.

It is noted that the front-back direction, the vertical direction or the horizontal direction which will be shown below is set for the sake of convenience of a description, and thus the present disclosure is by no means limited thereto when implemented.

### Construction of Lens Barrel

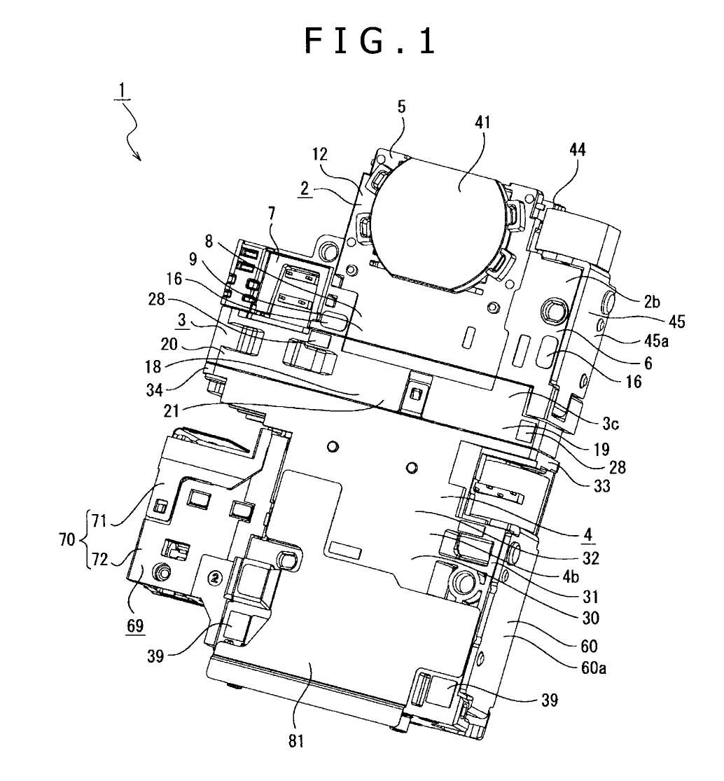

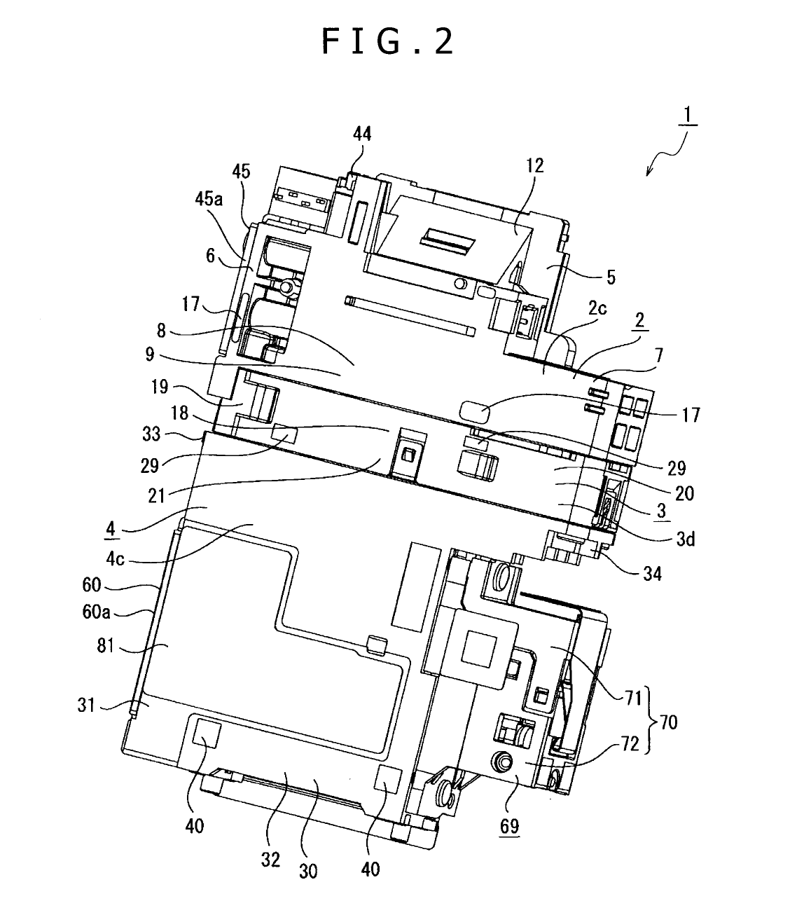

A lens barrel 1 according to a first embodiment of the present disclosure is disposed inside a chassis 101 (refer to FIGS. 1 to 4). The lens barrel 1 includes a first barrel case 2, a second barrel case 3, and a third barrel case 4. Predetermined portions including optical members are held in the first barrel case 2, the second barrel case 3, and the third barrel case 4, respectively. A lens, a light blocking plate, a diaphragm, an iris, a shutter, an optical filter, an imaging element, and the like, for example, are provided as the optical members.

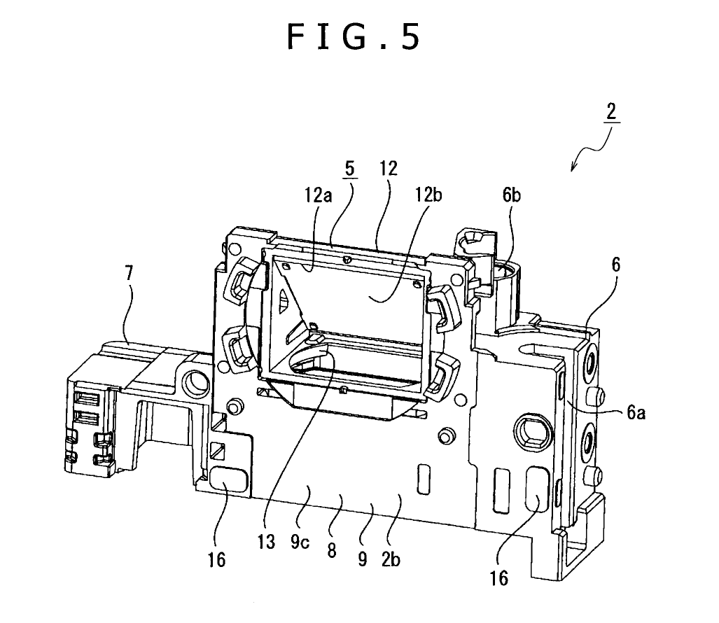

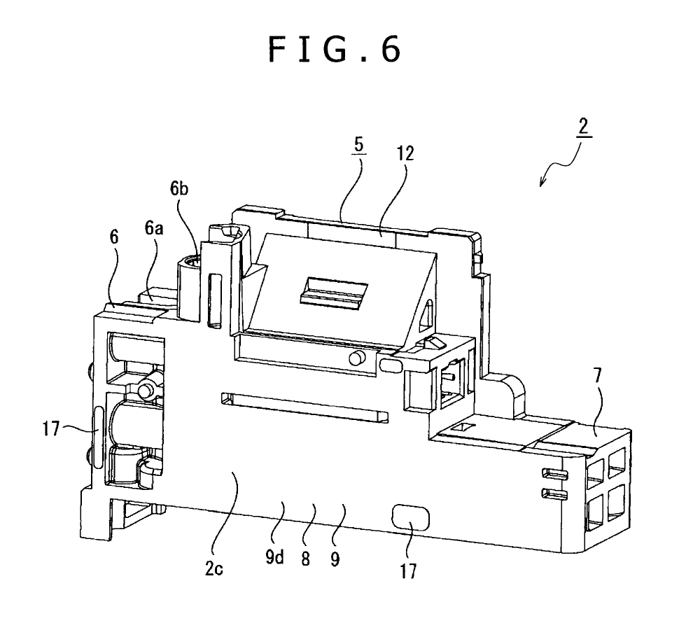

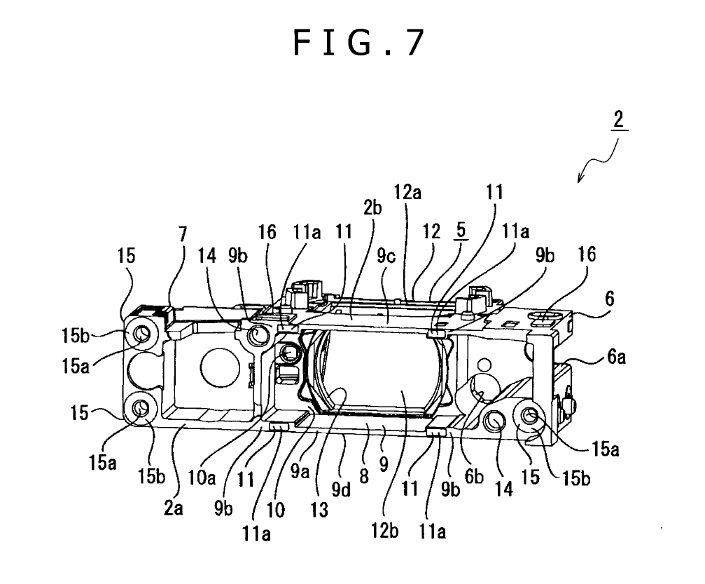

The first barrel case 2 is constructed by forming a base holding portion 5, a unit mounting portion 6, and a motor disposing portion 7 integrally with one another. In this case, the unit mounting portion 6 protrudes leftward from the base holding portion 5. Also, the motor disposing portion 7 protrudes rightward from the base holding portion 5 (refer to FIGS. 5 to 7).

The base holding portion 5 is provided as a box-like holding frame portion 8. In this case, a portion which is about-half a lower side of the box-like holding frame portion 8 is downward opened. The box-like holding frame portion 8 is composed of a square tubular peripheral surface portion 9 and a frame portion 10. In this case, the square tubular peripheral surface portion 9 vertically extends, and the frame portion 10 is provided continuously to an upper end portion of the peripheral surface portion 9.

A lower surface 9a of the square tubular peripheral surface portion 9 is formed in an approximately rectangular shape which is horizontally long. Abutment portions 11, 11, . . . are provided in four corners of the lower surface 9a, respectively. The abutment portions 11, 11, . . . slightly downward protrude, and head surfaces (lower surfaces) thereof are formed as abutment surfaces 11a, 11a, . . . , respectively. Portions of the peripheral surface portions 9 in which the abutment portions 11, 11, . . . are provided are provided as thick portions 9b, 9b, . . . , respectively. Each of the thick portions 9b, 9b, . . . is formed more thickly in longitudinal thickness than each of a front surface portion 9c and a back surface portion 9d of the peripheral portion 9.

A bearing hole 10a which is downward opened is formed in the frame portion 10.

A portion which is about half an upper side of the base holding portion 5 is provided as a member mounting portion 12. A rectangular opening portion 12a is formed in a front surface of the member mounting portion 12, and a portion on a back side of the opening portion 12a is provided as a disposition space 12b.

A communication hole 13 through which the peripheral surface portion 9 and the member mounting portion 12 communicate with each other is formed between the peripheral surface portion 9 and the member mounting portion 12, and is also formed in the frame portion 10.

The unit mounting portion 6 is formed in a vertically long box-like shape which is downward opened, and has a slit 6a for insertion which extends completely inside and outside through a portion extending from a left-hand side surface portion to an upper surface portion. A pin mounting hole 6b which vertically extends completely through an upper end portion of the unit mounting portion 6 is formed in the upper end portion of the unit mounting portion 6.

The motor disposing portion 7 is formed in a box-like shape which is downward opened.

Positioning holes 14, 14 which are downward opened are formed in a lower end portion of the first barrel case 2 so as to be horizontally separated from each other.

Screw fastening portions 15, 15, 15 are provided in left- and right-hand side end portions of the first barrel case 2, respectively. A screw fastening hole 15a which is downward opened is formed in each of the screw fastening portions 15, 15, 15, and an annular seating surface portion 15b is provided on an outer peripheral side of a lower side opening edge of the screw fastening hole 15a. The seating surface portion 15b is provided in a lower surface 2a of the first barrel case 2 so as to slightly protrude downward.

Falling protection protruding portions 16, 16 are provided in a front surface 2b of the first barrel case 2 so as to be horizontally separated from each other. Also, the falling protection protruding portions 16, 16 slightly protrude forward.

Inclination prevention protruding portions 17, 17 are provided in the back surface 2c of the first barrel case 2 so as to be horizontally separated from each other. Also, the inclination prevention protruding portions 17, 17 slightly protrude backward.

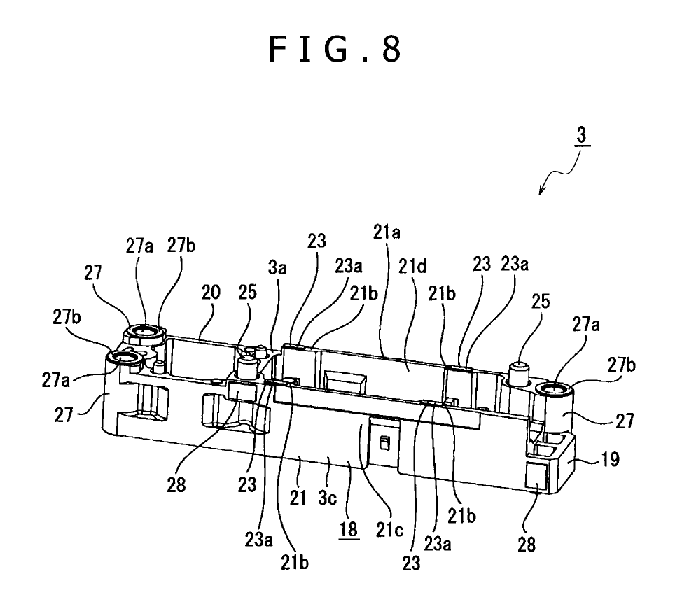

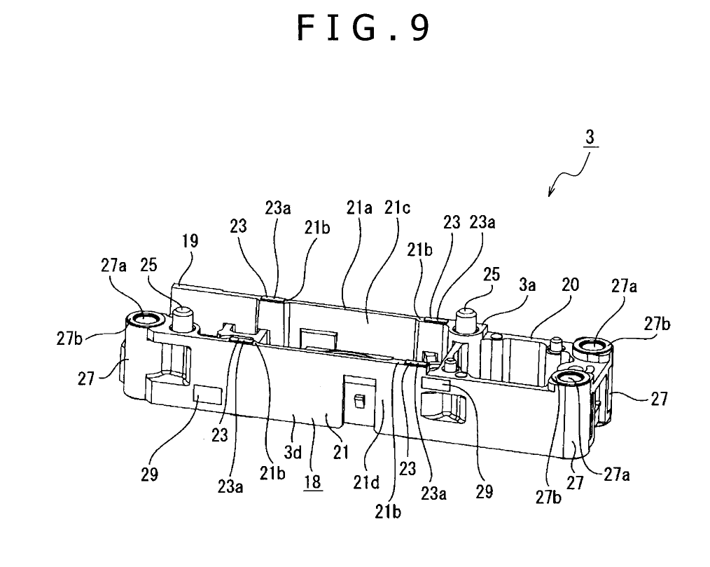

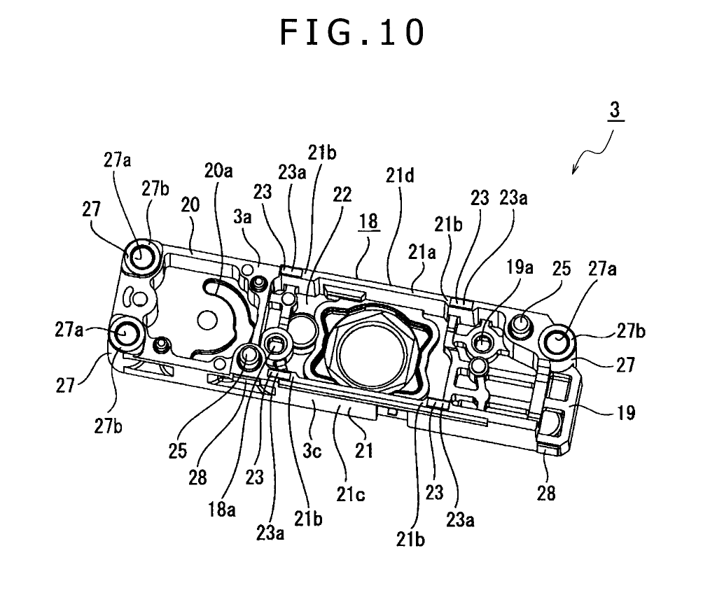

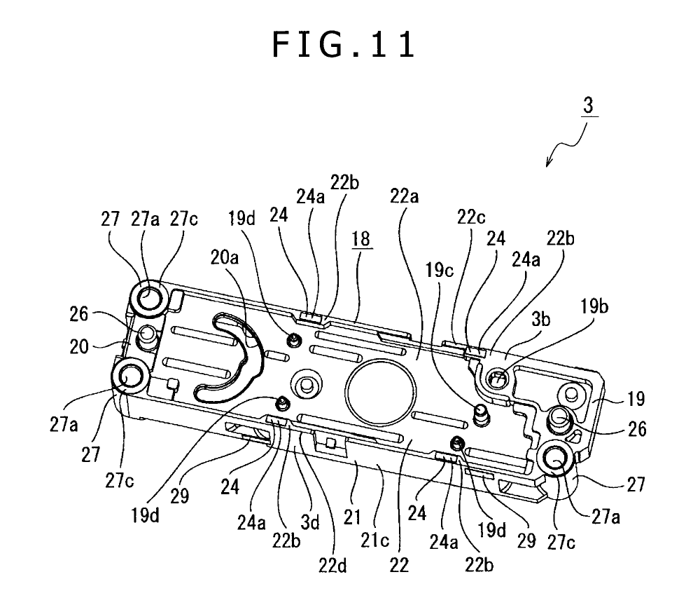

The second barrel case 3 is formed in a shape which is horizontally long. A central portion of the second barrel case 3 in the horizontal direction is set as a holding frame portion 18, and a left-hand side portion of the holding frame portion 18 is set as a mechanism supporting portion 19. Also, a right-hand side portion of the holding frame portion 18 is set as a motor mounting portion 20 (refer to FIGS. 8 to 11).

The holding frame portion 18 is formed in a box-like shape which is upward opened. Also, the holding frame portion 18 includes a square tubular peripheral wall portion 21 which vertically extends, and a frame wall portion 22 which is formed continuously to a lower end portion of the peripheral wall portion 21. A bearing hole 18a which is upward opened is formed in the holding frame portion 18.

An upper surface 21a of the peripheral wall portion 21 is formed in an approximately rectangular shape which is horizontally long. Abutment portions 23, 23, . . . are provided in four corners of the upper surface 21a, respectively. The abutment portions 23, 23, . . . slightly protrude upward, and head end surfaces (upper surfaces) thereof are formed as abutment surfaces 23a, 23a, . . . , respectively. Portions, of the peripheral wall portion 21, in which the abutment portions 23, 23, . . . are provided, respectively, are provided as thick portions 21b, 21b, . . . , respectively. Each of the thick portions 21b, 21b, . . . is more thickly formed in longitudinal thickness than each of a front surface 21c and a back surface 21d of the peripheral wall portion 21.

Abutment portions 24, 24, . . . are provided in four corners of a lower surface 22a of the frame wall portion 22, respectively. The abutment portions 24, 24, . . . slightly protrude downward, and head end surfaces (lower surfaces) thereof are formed as abutment surfaces 24a, 24a, . . . respectively. Portions, of the frame wall portion 2, in which the abutment portions 24, 24, . . . are formed, respectively, are formed as thick portions 22b, 22b, . . . , respectively. Each of the thick portions 22b, 22b, . . . is more thickly formed in longitudinal thickness than each of a front end surface 22c and a back end surface 22d of the frame wall portion 22.

A bearing hole 19a which is upward opened is formed on an upper surface side of the mechanism supporting portion 19. A bearing hole 19b which is downward opened is formed on a lower surface side of the mechanism supporting portion 19. A supporting shaft 19c which downward protrudes is provided in a lower surface of the mechanism supporting portion 19. Supporting pins 19d, 19d, 19d which protrude downward are provided on the lower surface of the mechanism supporting portion 19.

The motor mounting portion 20 is formed in a box-like shape which is upward opened. A pin insertion hole 20a which vertically extends perfectly through the motor mounting portion 20 is formed in the motor mounting portion 20. The pin insertion hole 20a is formed in an approximately circular arc-like shape.

Positioning pins 25, 25 which upward protrude are provided in an upper end portion of the second barrel case 3 so as to be longitudinally separated from each other. Also, positioning pins 26, 26 which downward protrude are provided in a lower end portion of the second barrel case 3 so as to be longitudinally separated from each other.

Screw fastening portions 27, 27, 27 are provided in left- and right-hand side end portions of the second barrel case 3, respectively. Screw insertion holes 27a, 27a, 27a which vertically extend perfectly through the screw fastening portions 27, 27, 27 are formed in the screw fastening portions 27, 27, 27 respectively. Circular ring-like seating surface portions 27b and 27c are provided on an outer peripheral side of an upper side opening edge, and an outer peripheral side of a lower side opening edge in each of the screw insertion holes 27a. The circular ring-like seating surfaces 27b and 27c are provided in the upper surface 3a and the lower surface 3b of the second barrel case 3, respectively, and slightly protrude upward and downward, respectively.

Falling prevention protruding portions 28, 28 are provided on the front surface 3c of the second barrel case 3 so as to be horizontally separated from each other, and so as to slightly protrude forward.

Falling prevention protruding portions 29, 29 are provided on the front surface 3d of the second barrel case 3 so as to be horizontally separated from each other, and so as to slightly protrude forward.

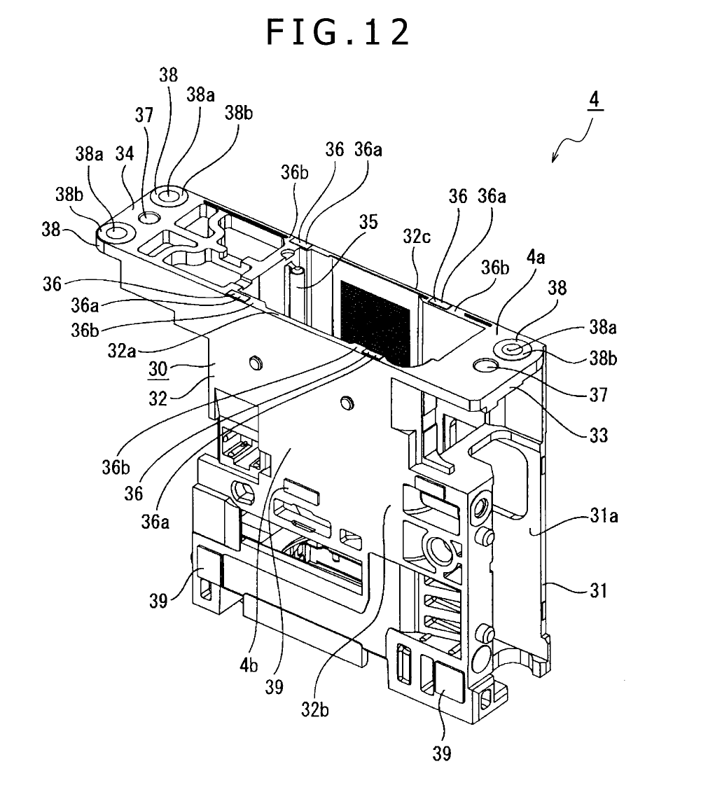

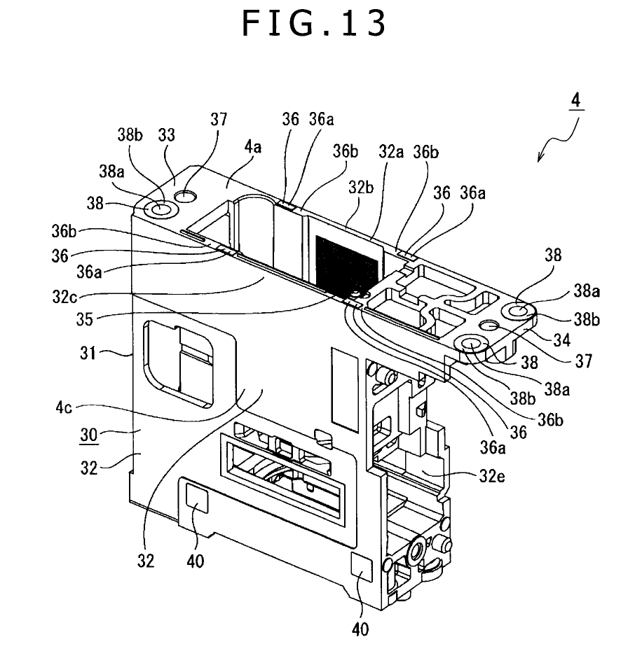

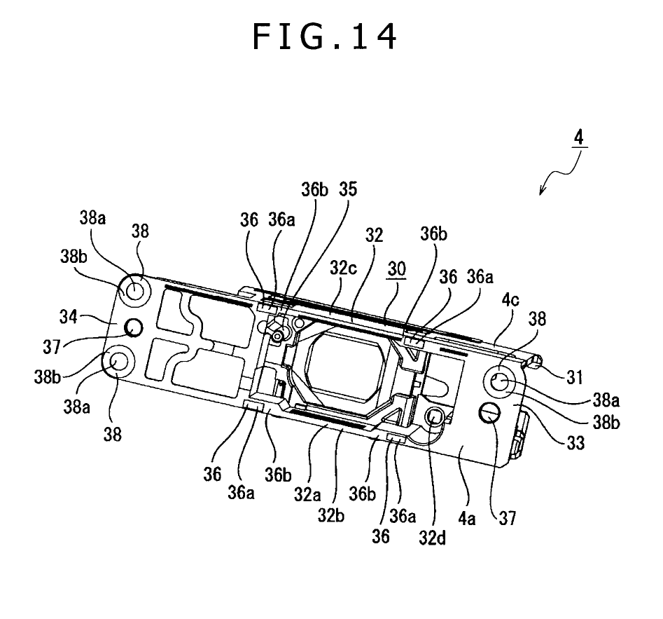

The third barrel case 4 is composed of a holding base portion 30, and a mechanism mounting portion 31 which is provided continuously to a left-hand side of the holding base portion 30 (refer to FIGS. 12 to 14).

The holding base portion 30 is composed of a holding frame portion 32, and protrusion-like portions 33, and 34. In this case, the holding frame portion 32 is formed in a square tubular shape which is vertically long. Also, the protrusion-like portions 33 and 34 protrude leftward and rightward from an upper end portion of the holding frame portion 32, respectively.

A guide portion 35 which vertically extends is provided in an inner peripheral surface of the holding frame portion 32.

Abutment portions 36, 36, . . . are provided in four corners of an upper surface 32a of the holding frame portion 32. The abutment portions 36, 36, . . . slightly protrude upward, and head end surfaces (upper surfaces) thereof are formed as abutment surfaces 36a, 36a, . . . , respectively. Portions, of the holding frame portion 32, in which the abutment portions 36, 36, . . . are provided, respectively, are provided as thick portions 36b, 36b, . . . , respectively. Each of the thick portions 36b, 36b, . . . is more thickly formed in longitudinal thickness than each of the front surface portion 32b and the back surface portion 32c of the holding frame portion 32.

A bearing hole 32d which is upward opened is formed in a lower end portion of the holding frame portion 32.

A member insertion hole 32e which extends perfectly inside and outside through the holding frame portion 32 is formed in a right-hand side surface portion of the holding frame portion 32.

A concave portion 31a for disposition which is leftward opened is formed in the mechanism mounting portion 31.

Positioning holes 37, 37 which are upward opened are formed in an upper end portion of the third barrel case 4 so as to be horizontally separated from each other.

Screw fastening portions 38, 38, 38 are provided in protrusion portions 33 and 34 of the third barrel case 4, respectively. Screw insertion holes 38a, 38a, 38a which vertically extend perfectly through the screw fastening portions 38, 38, 38 are formed in the screw fastening portions 38, 38, 38, respectively. A circular ring-like seating surface portion 38b is provided on an outer periphery side of an upper side opening edge of each of the screw insertion holes 38a. A seating surface portion 38b is provided on the upper surface 4a of the barrel case 4 so as to slightly extend upward.

Falling prevention protruding portions 39, 39 are provided on the front surface 4b of the third barrel case 4 so as to be horizontally separated from each other and so as to slightly protrude forward.

Inclination prevention protruding portions 40, 40 are provided on the back surface 4c of the third barrel case 4 so as to be horizontally separated from each other and so as to slightly protrude backward.

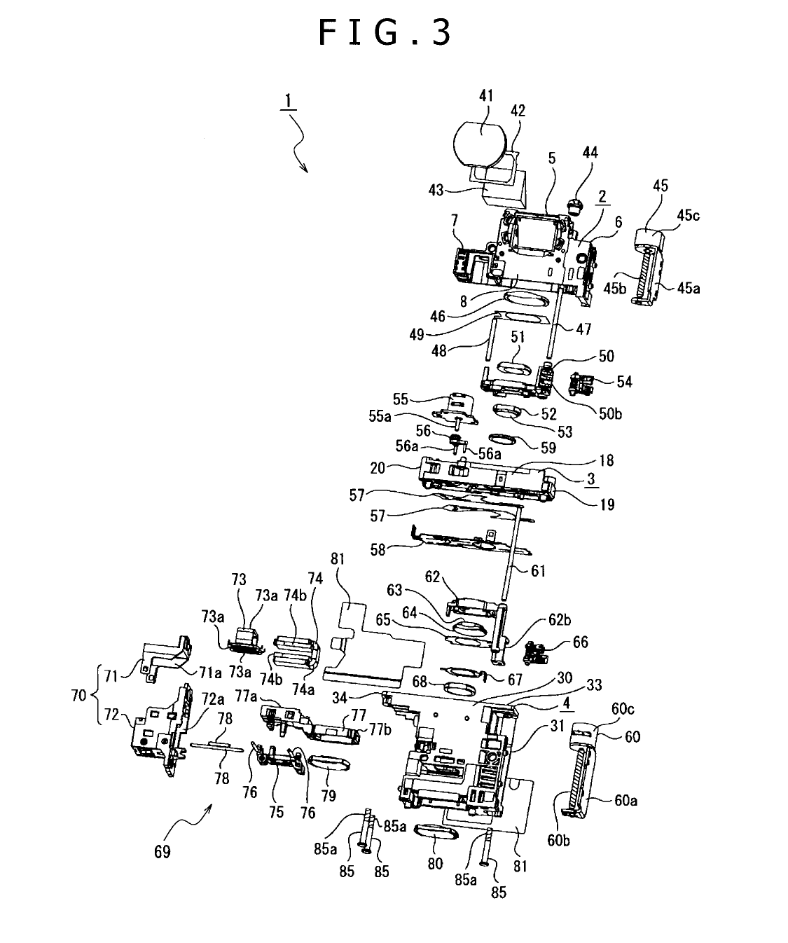

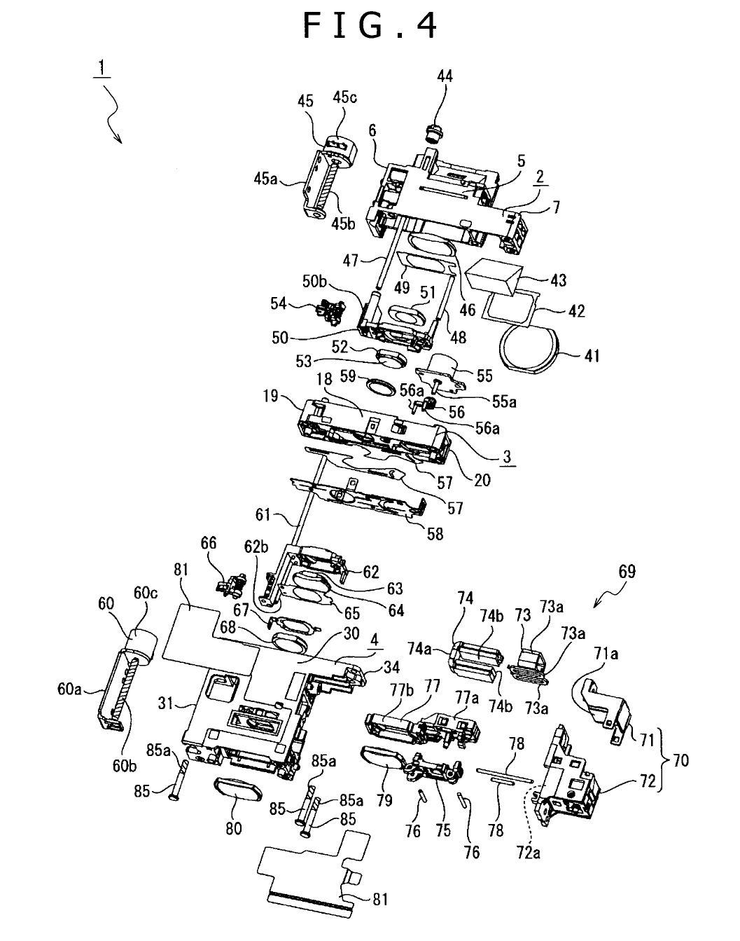

A first lens 41, a light blocking sheet 42, and a second lens 43 are inserted and disposed in order from the front side in a disposition space 12b formed in the member mounting portion 12 of the first barrel case 2 (refer to FIGS. 3 and 4). The first lens 41 is disposed on a most subject side so as to be directed forward. The light blocking sheet 42 is formed in a rectangular frame-like shape. The second lens 43 is a right angle prism for folding a light taken in through the first lens 41 downward at a right angle.

An eccentric pin 44 is mounted to the unit mounting portion 6 of the first barrel case 2. The eccentric pin 44 is inserted into a pin mounting hole 6b to be mounted to the unit mounting portion 6.

A drive unit 45 is inserted from a slit 6a for insertion into the unit mounting portion 6. The drive unit 45 includes a bracket 45a, a feed screw 45b, and a motor 45c. In this case, the feed case 45b is rotatably supported by the bracket 45a. Also, the motor 45c rotates the feed screw 45b. The bracket 45a of the drive unit 45 is mounted to the unit mounting portion 6 by the screwing or the like.

The third lens 46 is mounted to the frame portion 10 of the holding frame portion 8 of the first barrel case 2. The third lens 46 is mounted to a position where the communication hole 13 is covered.

A first guide shaft 47 is mounted between the eccentric pin 44 mounted to the first barrel case 2, and the bearing hole 19a of the second barrel case 3. Also, a second guide shaft 48 is mounted between the bearing hole 10a of the first barrel case 2, and the bearing hole 18a of the second barrel case 3. A light blocking sheet 49 is mounted to the lower side of the third lens 46 in the inside of the first barrel case 2.

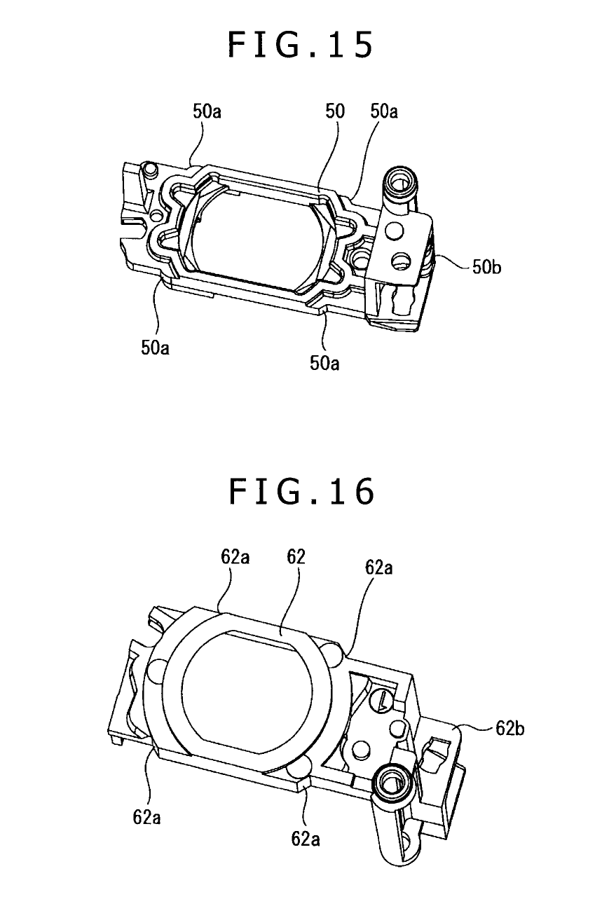

A zoom movement frame 50 is movably supported by both of the first guide shaft 47 and the second guide shaft 48. The zoom movement frame 50 is located inside the first barrel case 2. Cutout edges 50a, 50a, . . . are formed in positions, respectively, which are separated from one another back and forth and around in an outer peripheral edge of the zoom movement frame 50 (refer to FIG. 15). A nut mounting portion 50b is provided in the zoom movement frame 50.

A fourth lens 51, a fifth lens 52, and a sixth lens 53 are mounted in order from the upper side to the zoom movement frame 50 (refer to FIGS. 3 and 4).

A nut member 54 is mounted to a nut mounting portion 50b of the zoom movement frame 50. The nut member 54 is engaged with the feed screw 45b of the drive unit 45. Therefore, when the feed screw 45b is rotated by a driving force of the motor 45c, the nut member 54 is fed in the direction corresponding to the rotation direction of the feed screw 45b. Along with the feeding movement of the nut member 54, the zoom movement frame 50, the fourth lens 51, the fifth lens 52, and the sixth lens 53 are all moved in the vertical direction.

An iris motor 55 is mounted to the upper surface of the motor mounting portion 20 of the second barrel case 3 by the screwing or the like. A vane driving member 56 is mounted to an output shaft 55a of the iris motor 55. The vane driving member 56 includes two drive pins 56a, 56a which are located in a circular-arc style with the output shaft 55a as a center. In a state in which the iris motor 55 is mounted to the motor mounting portion 20, the drive pins 56a, 56a of the vane driving member 56 are inserted from the upper side into the pin insertion holes 20a, 20a, respectively.

Iris vanes 57, 57 are pivotally supported by the lower surface 3b side of the second barrel case 3. The iris vanes 57, 57 are supported by the second barrel case 3 in a state of being pressed from the lower side by a vane pressing member 58 mounted to the lower surface side of the second barrel case 3.

For the iris vanes 57, 57, supporting pins 19d, 19d, 19d of the mechanism supporting portion 19 are inserted into long holes which are formed in two portions every iris vane 57. The iris vanes 57, 57 are guided by the supporting pins 19d, 19d, 19d to be movably supported in a direct movement direction by the second barrel case 3. Also, the other end portions of the iris vanes 57, 57 are slidably supported by the drive pins 56a, 56a of the vane driving member 56, respectively. Therefore, the vane driving members 56, 56 are rotated by the driving force of the iris motor 55, whereby the iris vanes 57, 57 suffer the direct movement to change a shielding state of a light quantity.

A seventh lens 59 is mounted to the frame wall portion 22 of the holding frame portion 18 of the second barrel case 3.

In the mechanism mounting portion 31 of the third barrel case 4, a mechanism unit 60 is mounted to the concave portion 31a of disposition. The mechanism unit 60 includes a bracket 60a, a feed screw 60b, and a motor 60c. In this case, the feed screw 60b is rotatably supported by the bracket 60a. Also, the motor 60c rotates the feed screw 60b. The bracket 60a of the mechanism unit 60 is mounted to the mechanism mounting portion 31 by the screwing or the like.

A third guide shaft 61 is mounted between the bearing hole 19b of the second barrel case 3, and the bearing hole 32d of the third barrel case 4.

A focus movement frame 62 is movably supported by both of the third guide shaft 61, and a guide shaft portion 35 provided in the third barrel case 4. The focus movement frame 62 is located inside the third barrel case 4. Also, cutout edges 62a, 62a, . . . are formed in the positions, respectively, which are separated from one another back and forth and around in an outer periphery edge of the focus movement frame 62 (refer to FIG. 16). A nut mounting portion 62b is provided in the focus movement frame 62.

A eighth lens 63, a ninth lens 64, and an annular light blocking sheet 65 are mounted in order from the upper side to the focus movement frame 62 (refer to FIGS. 3 and 4).

A nut member 66 is mounted to a nut mounting portion 62b of the focus movement frame 62. The nut member 66 is engaged with the feed screw 60b of the mechanism unit 60 through a member insertion hole 32e. Therefore, when the feed screw 60b is rotated by a driving force of the motor 60c, the nut member 66 is fed in the direction corresponding to the rotation direction of the feed screw 60b. Along with the feeding movement of the nut member 66, the focus movement frame 62, the eighth lens 63, the ninth lens 64, and the light blocking sheet 65 are all moved in the vertical direction.

A pressing member 67 and a tenth lens 68 are mounted to the inside of the holding base portion 30 of the third barrel case 4. The tenth lens 68 is pressed from the upper side by the pressing member 67.

An antivibration unit 69 is disposed inside the holding base portion 30 of the third barrel case 4. The antivibration unit 69 is constructed by disposing necessary portions in a case body 70. The case body 70 is constructed by vertically coupling a first case portion 71 and a second case portion 72 to each other. The insides of the first case portion 71 and the second case portion 72 are formed as storage disposing portions 71a, 71a, respectively.

Both of a coil body 73 and a magnetic body 74 are mounted and disposed in the first case portion 71 located on the upper side. The coil body 73 is constructed by coupling drive coils 73a, 73a, 73a to one another. The coil body 73 is mounted to the second case body 72. The magnetic body 74 is composed of a U letter-like yoke 74a, and magnets 74b, 74b which are mounted to the U letter-like yoke 74a so as to face each other.

A movement base 75 is supported movably in a front-back direction by the second case portion 72 located on the lower side. The movement base 75 is movably supported by the second case portion 72 through first guide shafts 76, 76.

A lens holding frame 77 is horizontally, movably supported by the movement base 75. In the lens holding frame 77, a supported portion 77a and a lens holding portion 77b are formed integrally with each other. In the lens holding frame 77, the supported portion 77a is horizontally, movably supported by the movement base 75 through second guide shafts 78, 78. An eleventh lens 79 is mounted to the lens holding portion 77b. The magnetic body 74 is mounted to the lens holding frame 77.

A twelfth lens 80 is mounted to the lower end portion of the third barrel case 4. Shielding sheets 81, 81 are stuck to the front surface and the back surface of the third barrel case 4, respectively.

### Lens Construction and the Like of Lens Barrel

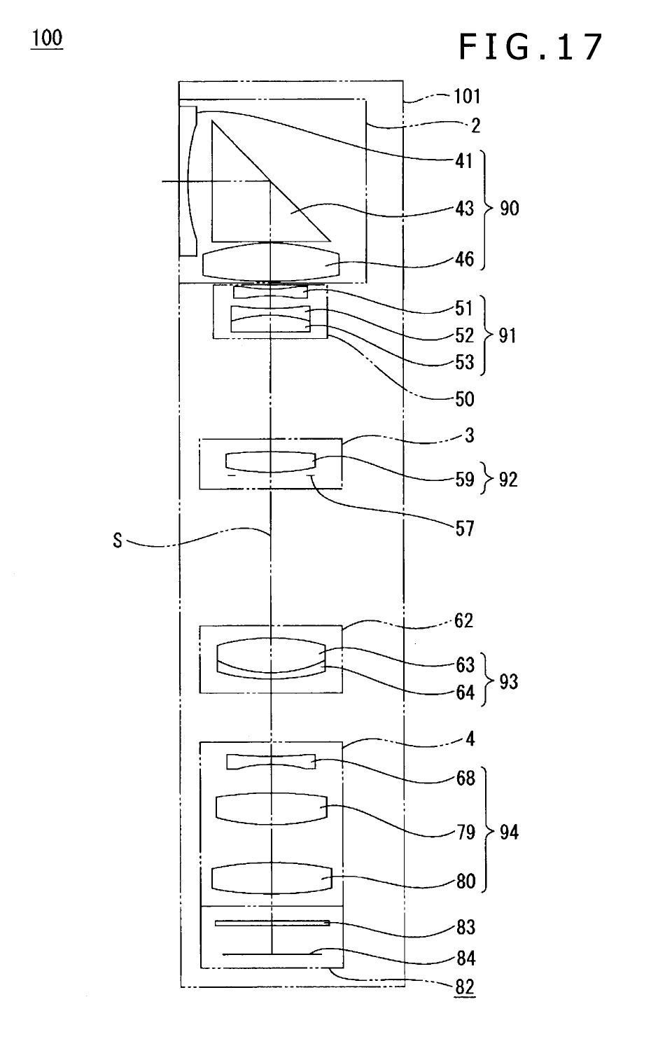

A lens construction and the like of the lens barrel 1 constructed in the manner as described above will be described below (refer to FIG. 17).

In the lens barrel 1, a first lens group 90, a second lens group 91, a third lens group 92, a fourth lens group 93, and a fifth lens group 94 are disposed in order from an object side to an image side.

The first lens group 90 is a fixed group. Thus, the first lens group 90 is composed of a first lens 41, a second lens 43, and a third lens 46 which are disposed on an optical axis S in order from the object side to the image side, and is mounted to the first barrel case 2. The second lens 43 is a right angle prism, and the optical axis S is folded by about 90°. Therefore, the optical axis S from the object side up to the second lens 43 is formed so as to extend in a front-back direction, and the optical axis S from the second lens 43 up to the object side is also formed so as to extend in the vertical direction.

The second lens group 91 is a movable group (zoom movement group). Thus, the second lens group 91 is composed of a fourth lens 51, a fifth lens 52, and a sixth lens 53 which are disposed on the optical axis S in order from the object side to the image side, and is mounted to the zoom movement frame 50. The fifth lens 52 and the sixth lens 53 are provided in the form of a cemented lens.

The third lens group 92 is a fixed group and is composed of a seventh lens 59 disposed on the optical axis S. Also, the third lens group 92 is mounted together with the iris vanes (diaphragms) 57, 57 to the second barrel case 3.

The fourth lens group 93 is a movable group (focus movement group). Thus, the fourth lens group 93 is composed of an eighth lens 63 and a ninth lens 64 which are disposed on the optical axis S in order from the object side to the image side, and is mounted to the focus movement frame 62. The eighth lens 63 and the ninth lens 64 are provided in the form of a cemented lens.

The fifth lens group 94 is a fixed group. Thus, the fifth lens group 94 is composed of a tenth lens 68, an eleventh lens 79, and a twelfth lens 80 which are disposed on the optical axis S in order from the object side to the image side. Both of the tenth lens 68 and the twelfth lens 80 are mounted to the third barrel case 4. The eleventh lens 79 is mounted to the lens holding frame 77 of the antivibration unit 69 so as to function as an antivibration lens. Thus, the eleventh lens 79 is moved in a direction orthogonal to the optical axis S, thereby carrying out blurring correction.

An imaging unit 82 is mounted to the lower end portion of the third barrel case 4. The imaging unit 82 is disposed on the image side of the fifth lens group 94. Also, the imaging unit 82 includes an infrared cut filter 83 and an imaging element 84 in order from the object side to the image side.

### Assembly of Barrel Cases

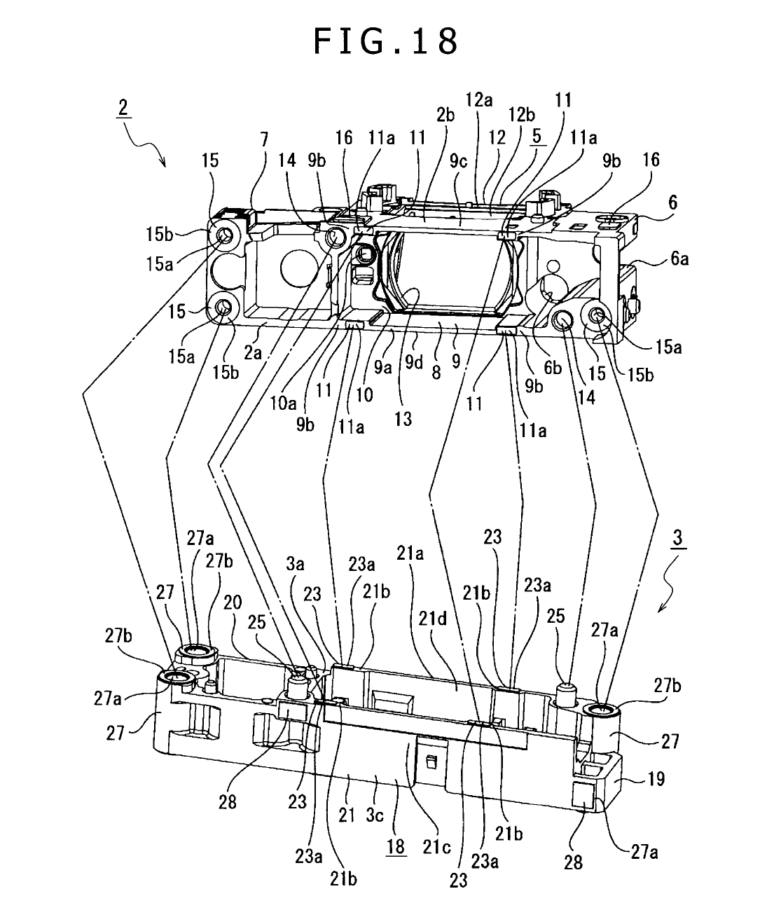

Hereinafter, assembly of the barrel case will be described with reference to FIGS. 18 to 23.

The first barrel case 2, the second barrel case 3, and the third barrel case 4 are coupled to one another in order from the upper side to be assembled in a state in which the portions described above are mounted thereto.

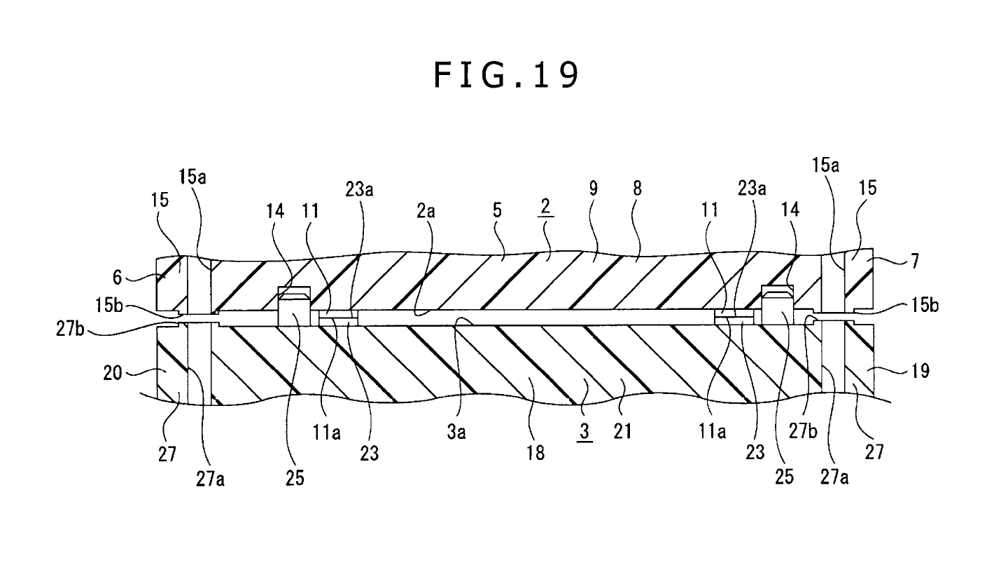

As shown in FIG. 18, the positioning pins 25, 25 of the second barrel case 3 are inserted into the positioning holes 14, 14 of the first barrel case 2, respectively, to be coupled thereto, thereby assembling the first barrel case 2 and the second barrel case 3. In a state in which the positioning pins 25, 25 are inserted into the positioning holes 14, 14, respectively, as shown in FIG. 19, the abutment surfaces 11a, 11a, . . . of the abutment portions 11, 11, . . . of the first barrel case 2, and the abutment surfaces 23a, 23a, . . . of the abutment portions 23, 23, . . . of the second barrel case 3 are made to face-contact each other, respectively. In addition, a small gap is defined between the seating surface portions 15b, 15b, . . . of the screw fastening portions 15, 15, . . . of the first barrel case 2, and the seating surface portions 27b, 27b, . . . of the screw fastening portions 27, 27, . . . of the second barrel case 3.

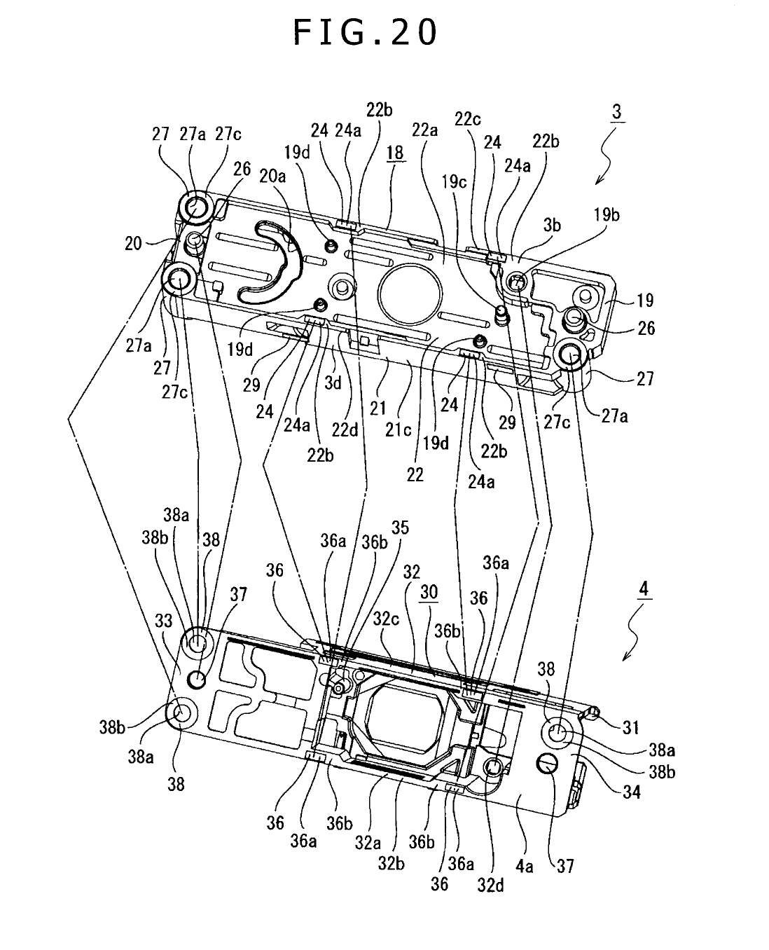

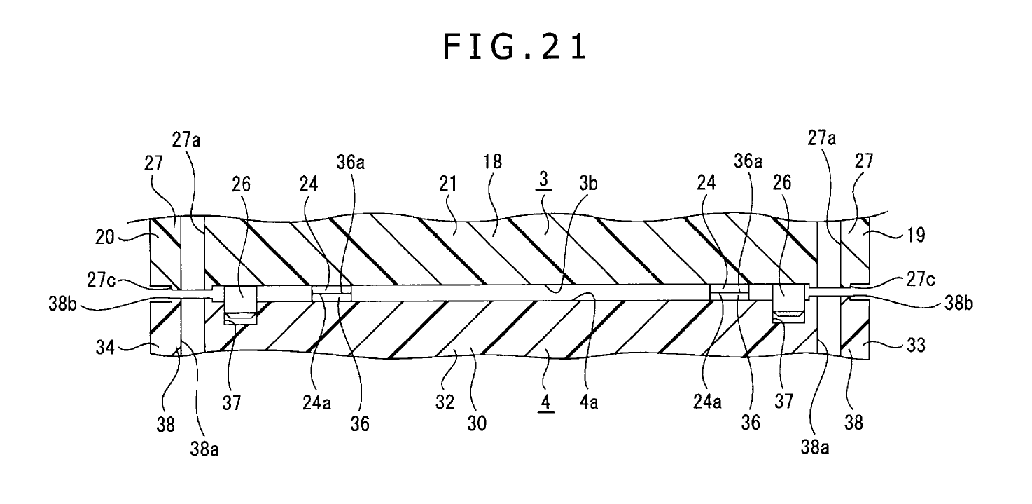

As shown in FIG. 20, the positioning pins 26, 26 of the third barrel case 3 are inserted into the positioning holes 37, 37 of the third barrel case 3, respectively, to be coupled thereto, thereby assembling the second barrel case 3 and the third barrel case 4. In a state in which the positioning pins 26, 26 are inserted into the positioning holes 37, 37, respectively, as shown in FIG. 21, the abutment surfaces 24a, 24a, . . . of the abutment portions 24, 24, . . . of the second barrel case 3, and the abutment surfaces 36a, 36a, . . . of the abutment portions 36, 36, . . . of the third barrel case 4 are made to face-contact each other, respectively. In addition, a small gap is defined between the seating surface portions 27c, 27c, . . . of the screw fastening portions 27, 27, . . . of the second barrel case 3, and the seating surface portions 38b, 38b, . . . of the screw fastening portions 38, 38, . . . of the third barrel case 4.

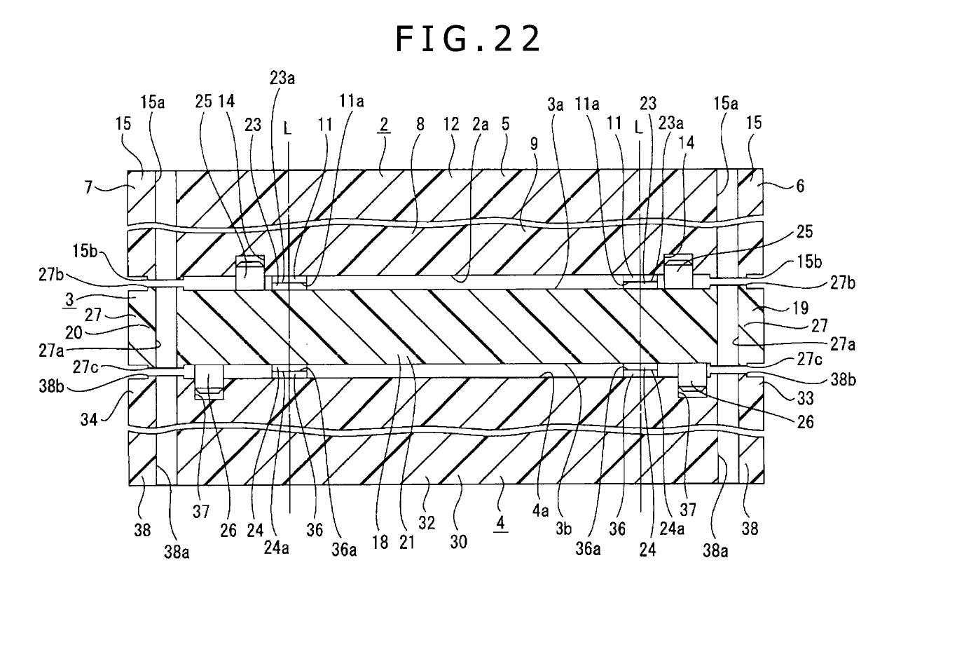

As described above, in a state in which the first barrel case 2 and the second barrel case 3 are coupled to each other, and the second barrel case 3 and the third barrel case 4 are coupled to each other (refer to FIG. 22), the first barrel case 2, the second barrel case 3, and the third barrel case 4 are fixed to one another by using the mounting screws 85, 85, 85. A head portion of each of the mounting screws 85, 85, 85 is provided as a screwing portion 85a. In this case, for example, the screwing portion 85a is inserted through a screw fastening hole 38a of the third barrel case 4, a screw fastening hole 27a of the second barrel case 3, and a screw fastening hole 15a of the first barrel case 2 in this order. As a result, the screwing portion 85a is screwed into the screw fastening hole 15a of the first barrel case 2.

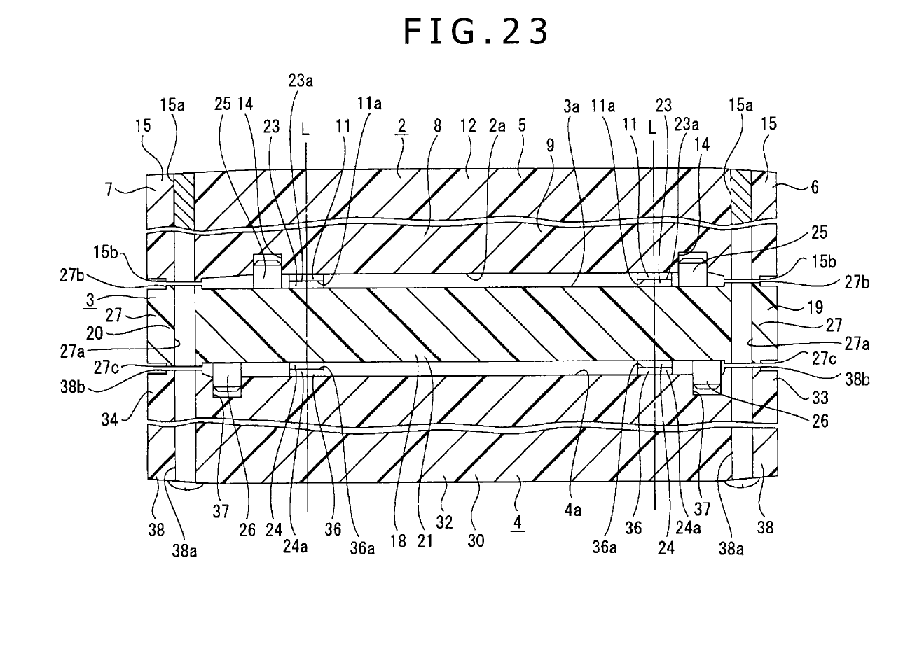

A force in a direction of coming close to the screw fastening portions 27, 27, 27 provided on the left- and right-hand side end portions of the second barrel case 3 is applied to the screw fastening portions 15, 15, 15 provided on the left- and right-hand side end portions of the first barrel case 2, respectively, and the screw fastening portions 38, 38, 38 provided on the left- and right-hand side end portions of the third barrel case 4 by the mounting screws 85, 85, 85, respectively (refer to FIG. 23).

At this time, as described above, the small gap is defined between the seating surface portions 15b, 15b, . . . of the first barrel case 2, and the seating surface portions 27b, 27b, . . . of the second barrel case 3. Also, the small gap is defined between the surface portions 27c, 27c, . . . of the second barrel case 3, and the seating surface portions 38b, 38b, . . . of the third barrel case 4, respectively. Therefore, the left- and right-hand side end portions of the first barrel case 2, and the left- and right-hand side end portions of the third barrel case 4 are slightly deformed in a direction of coming close to the left- and right-hand side end portions of the second barrel case 3 (refer to FIG. 23). As a result, the abutment surfaces 11a, 11a, . . . of the first barrel case 2, and the abutment surfaces 23a, 23a, . . . of the second barrel case 3 are made to come in close contact with each other. Also, the abutment surfaces 11a, 11a, . . . of the first barrel case 2, and the abutment surfaces 36a, 36a, . . . of the third barrel case 4 are made to come in close contact with each other.

As described above, in the lens barrel 1, the outer periphery sides of the holding frame portions 8, 18, and 32 of the second barrel case 3 and the third barrel case 4 are provided with the screw fastening portions 15, 15, 15, 27, 27, 27, 38, 38, and 38 to which the first barrel case 2, the second barrel case 3, and the third barrel case 34 coupled to one another are fastened by using the mounting screws 85, 85, 85.

Therefore, a force in a direction in which the abutment portion 11, the abutment portion 23 and the abutment portion 24, and the abutment portion 36 which are provided in the holding frame portions 8, 18, and 32, respectively, come close to one another is easy to generate by the mounting screws 85, 85, 85. As a result, the abutment portion 11, the abutment portion 23, and the abutment portion 24 can be made to reliably come in contact with one another.

In addition, in a state in which the first barrel case 2, the second barrel case 3, and the third barrel case 4 are coupled to one another, the seating surface portion 15b, the seating surface portion 27b and the seating surface portion 27c, and the seating surface portion 38b of the screw fastening portions 15, 27, and 38 are set in a non-contact state.

Therefore, the abutment portion 11, the abutment portion 23 and the abutment portion 24, and the abutment portion 36 which are provided in the holding frame portions 8, 18, and 32, respectively, are made to come in close contact with one another. Thus, it is possible to ensure the satisfactory contact state among the abutment portion 11, the abutment portion 23, the abutment portion 24, and the abutment portion 36.

In addition, as described above, in the state in which the first barrel case 2, the second barrel case 3, and the third barrel case 4 are coupled to one another, the abutment portions 11, 11, . . . , the abutment portions 23, 23, . . . , the abutment portions 24, 24, . . . , and the abutment portions 36, 36, . . . are disposed so as to be arranged on one straight lines L, L, . . . in the coupling direction, respectively (refer to FIGS. 22 and 23).

Therefore, it is possible to ensure the stable coupling state among the first barrel case 2, the second barrel case 3, and the third barrel case 4. As a result, it is possible to prevent the generation of the deformation and the strain in the state in which the first barrel case 2, the second barrel case 3, and the third barrel case 4 are coupled to one another.

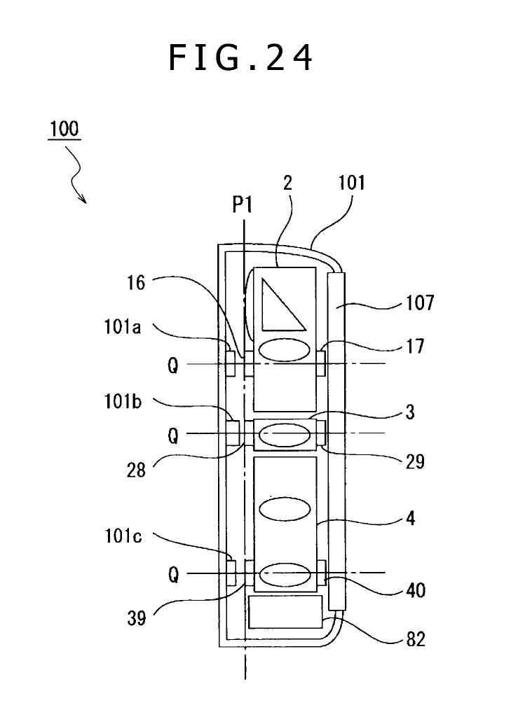

The lens barrel 1 constructed in the manner as described above is disposed inside the chassis 101 (refer to FIG. 24).

The first barrel case 2, the second barrel case 3, and the third barrel case 4 of the lens barrel 1 are provided with the falling prevention protruding portions 16, 16, 28, 28, 39, and 39 which protrude forward, respectively. Forward protrusion amounts of falling prevention protruding portions 16, 16, 28, 28, 39, and 39 are made identical to one another, and the head end portions of the falling prevention protruding portions 16, 16, 28, 28, 39, and 39 exist in the same position P1.

The chassis 101 is provided with reception protruding portions 101a, 101a, 101b, 101b, 101c, 101c which protrude backward in positions corresponding to the falling prevention protruding portions 16, 16, 28, 28, 39, and 39, respectively.

A protrusion amount of reception protruding portions 101b, 101b located so as to face the falling prevention protruding portions 28, 28 of the second barrel case 3 is set larger than each of protrusion amounts of reception protruding portions 101a, 101a, 101c, and 101c. Therefore, the gap defined between the falling prevention protruding portions 28, 28 and the reception protruding portions 101b, 101b is set smaller than each of the gap defined between the falling prevention protruding portions 16, 16 and the reception protruding portions 101a, 101a, and the gap defined between the falling prevention protruding portions 39, 39 and the reception protruding portions 101c, 101c.

In addition, as described above, the first barrel case 2, the second barrel case 3, and the third barrel case 4 of the lens barrel 1 are provided with inclination prevention protruding portions 17, 17, 29, 29, 40, and 40 which protrude backward, respectively. The inclination prevention protruding portions 17, 17, 29, 29, 40, and 40 are each disposed so as to face the inner surface of the display device 107 disposed on a back surface side of an imaging apparatus 100 which will be described later.

As described above, the lens barrel 1 is provided with the falling prevention protruding portions 16, 16, 28, 28, 39, and 39 which can be made to come contact with the inner surface of the chassis 101. Thus, when the force in the forward direction is applied to the lens barrel 1 based on the external force, the falling prevention protruding portions 16, 16, 28, 28, 39, and 39 can be made to come in contact with the reception protruding portions 101a, 101a, 101b, 101, 101c, and 101c, respectively.

Therefore, it is possible to prevent the generation of the deformation and the strain of the lens barrel 1 due to the external force.

In addition, the falling prevention protruding portions 16, 16, 28, 28, 39, and 39 are located so as to face the reception protruding portions 101a, 101a, 101b, 101, 101c, and 101c, respectively.

Therefore, the rigidity of the chassis 101 is increased by the reception protruding portions 101a, 101a, 101b, 101, 101c, and 101c. Thus, it is possible to prevent the deformation and the strain of the lens barrel 1 when the external force is generated.

In addition, the lens barrel 1 is provided with the inclination protruding portions 17, 17, 29, 29, 40, and 40 which can be made to come in contact with the inner surface of the display device 107. Therefore, when the force in the backward direction is applied to the lens barrel 1 by the external force, the inclination protruding portions 17, 17, 29, 29, 40, and 40 can be made to come in contact with the inner surface of the display device 107.

Therefore, it is possible to prevent the generation of the deformation and the strain of the lens barrel 1 due to the external force.

In addition thereto, the falling prevention protruding portions 16, 16, 28, 28, 39, and 39, and the inclination protruding portions 17, 17, 29, 29, 40, and 40 are provided in positions Q, Q, . . . which are arranged on one straight line in the longitudinal direction.

Therefore, the effect of preventing the deformation and the strain of the lens barrel 1 due to the external force can be enhanced by the falling prevention protruding portions 16, 16, 28, 28, 39, and 39, and the inclination protruding portions 17, 17, 29, 29, 40, and 40.

In addition thereto, as described above, in the lens barrel 1, the gap defined between the falling prevention protruding portions 28, 28 and the reception protruding portions 101b, 101b is set smaller than each of the gap defined between the falling prevention protruding portions 16, 16 and the reception protruding portions 101a, 101a, and the gap defined between the falling prevention protruding portions 39, 39, and the reception protruding portions 101c, 101c.

Therefore, in the lens barrel 1, the falling prevention protruding portions 28, 28 existing at the central portion in the vertical direction in which the deformation is easy to most generate in the phase of generation of the external force are easy to most come in contact with the reception protruding portions 101b, 101b. As a result, it is possible to effectively prevent the deformation and the strain of the lens barrel 1.

Note that, in the foregoing, there is shown the case where the protrusion amount of reception protruding portions 101b, 101b located so as to face the falling prevention protruding portions 28, 28 of the second barrel case 3 is made larger than each of the protrusion amounts of reception protruding portions 101a, 101a, 101c, and 101c, thereby reducing the gap defined between the falling prevention protruding portions 28, 28 and the reception protruding portions 101b, 101b.

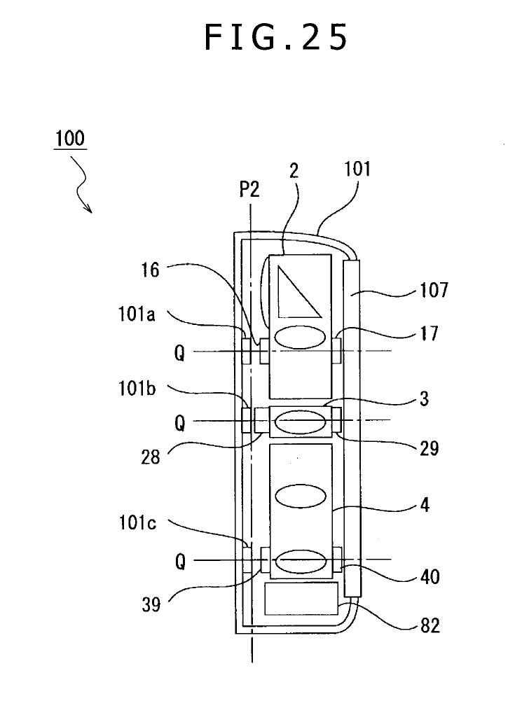

Contrary to this, a construction may also be adopted in which as shown in FIG. 25, the protrusion amounts of reception protruding portions 101a, 101a, 101b, 101b, 101c, and 101c are made identical to one another, and the protrusion amount of falling prevention protruding portions 28, 28 is made larger than each of the protrusion amounts of falling prevention protruding portions 16, 16, 39, and 39, thereby reducing the gap defined between the falling prevention protruding portions 28, 28, and the reception protruding portions 101b, 101b. In this case, the head end surfaces of the reception protruding portions 101a, 101a, 101b, 101b, 101c, and 101c exist in the same position P2 in the longitudinal direction.

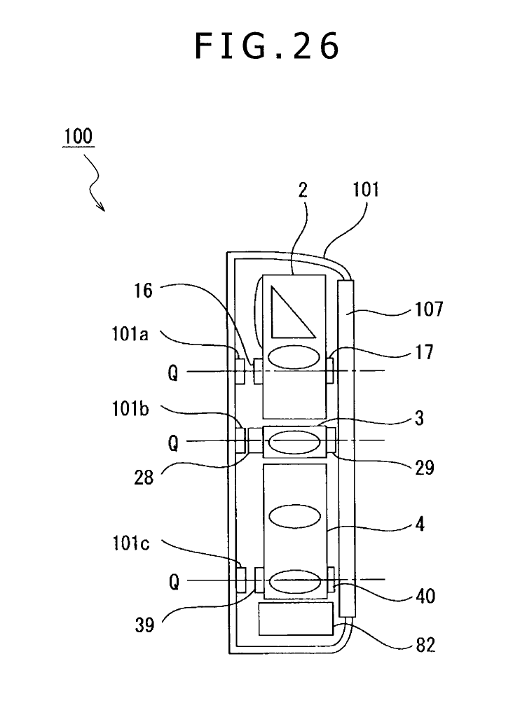

In addition, a construction may also be adopted in which as shown in FIG. 26, the protrusion amount of inclination prevention protruding portions 29, 29 is made larger than each of the protrusion amounts of inclination prevention protruding portions 17, 17, 40, and 40, thereby reducing the gap defined between the inclination prevention protruding portions 29, 29 and the inner surface of the display device 107.

The gap defined between the inclination prevention protruding portions 29, 29 and the inner surface of the display device 107 is reduced in such a manner, whereby in the lens barrel 1, the inclination prevention protruding portions 29, 29 existing in the central portion of the lens barrel 1 in the vertical direction in which the deformation is easy to most generate in the phase of generation of the external force are easy to most come in contact with the inner surface of the display device 107. As a result, it is possible to effectively prevent the deformation and the strain of the lens barrel 1.

In addition, in the lens barrel 1, of the holding frame portions 8, 18, and 32 of the first barrel case 2, the second barrel case 3, and the third barrel case 4, the portions in which the abutment portions 11, 23, 24, and 36 are provided, respectively, are provided as other portions, for example, the thick portions 9b, 21b, 22b, and 36b each of which is thicker than each of the front surface portions 9c, 21c, and 22c, and the back surface portions 9d, 21d, and 22d.

Therefore, the abutment portions 11, 23, 24, and 36 provided on the end surfaces of the high-rigidity portions, respectively, as the thick portions 9b, 21b, 22b, and 36b are made to abut against each other. Thus, the strength in the state in which the lens barrel 1 is assembled is high, and thus it is possible to effectively prevent the generation of the deformation and the strain in the lens barrel 1.

It is noted that the cutout edges 50a, 50a, . . . are formed in the positions, respectively, which are separated from one another back and forth and around in the outer periphery edge of the zoom movement frame 50 which is moved in the optical axis direction in the inside of the first barrel case 2. In addition, the cutout edges 62a, 62a, . . . are formed in the positions, respectively, which are separated from one another back and forth and around in the outer periphery edge of the focus movement frame 60 which is moved in the optical axis direction in the inside of the third barrel case 4.

Therefore, the contact between the zoom movement frame 50 and the focus movement frame 62, and the thick portions 9b, 9b, 21b, 21b, 22b, 22b, 36b, 36b, . . . is avoided by the cutout edges 50a, 50a, . . . , 62a, 62a, . As a result, the smooth movement state is ensured.

### Others

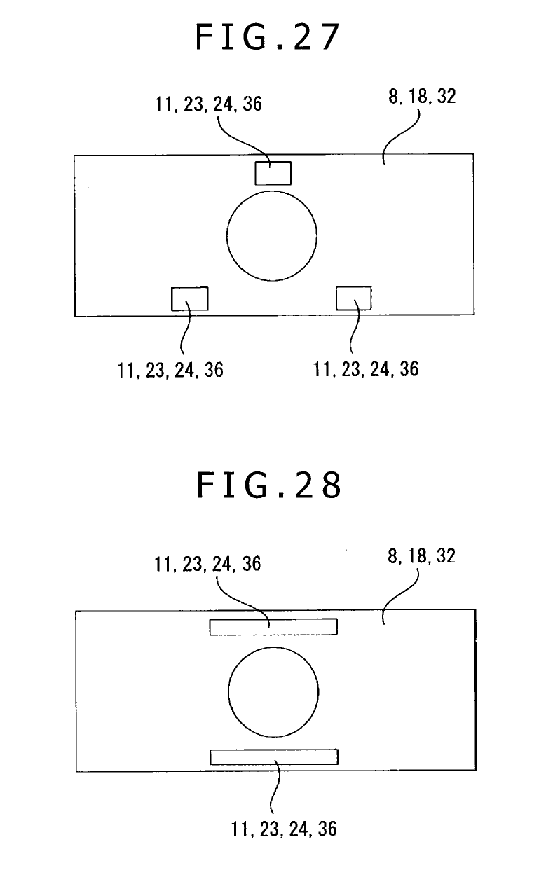

Hereinafter, the number and shapes of the abutment portions will be described (refer to FIGS. 27 to 30).

In the foregoing, there has been shown the case where the four abutment portions 11, 11, . . . , the four abutment portions 23, 23, . . . , the four abutment portions 24, 24, and the four abutment portions 36, 36 are provided. However, an arbitrary number of abutment portions can be provided as long as plural abutment portions 11, plural abutment portions 23, plural abutment portions 24, and plural abutment portions 36 are provided (refer to FIGS. 27 and 28).

For example, as shown in FIG. 27, the holding frame portions 8, 18, and 32 of the first barrel case 2, the second barrel case 3, and the third barrel case 4 may be provided with three abutment portions 11, 11, 11, three abutment portions 23, 23, 23, and three abutment portions 24, 24, 24, and three abutment portions 36, 36, 36, respectively.

The number of abutment portions 11, 23, 24, and 36 is reduced in such a manner, thereby making it possible to further simplify the construction of the lens barrel 1.

When three abutment portions 11, 11, 11, three abutment portions 23, 23, 23, and three abutment portions 24, 24, 24, and three abutment portions 36, 36, 36 are provided, preferably, three abutment portions 11, 11, 11, three abutment portions 23, 23, 23, and three abutment portions 24, 24, 24, and three abutment portions 36, 36, 36 are provided at intervals of 120°. Three abutment portions 11, 11, 11, three abutment portions 23, 23, 23, and three abutment portions 24, 24, 24, and three abutment portions 36, 36, 36 are provided at intervals of 120°, whereby the coupling state among the first barrel case 2, the second barrel case 3, and the third barrel case 4 can be stabilized after the simplification of the construction of the lens barrel 1 has been ensured.

In addition, for example, a construction may also be adopted in which as shown in FIG. 28, the holding frame portions 8, 18, and 32 of the first barrel case 2, the second barrel case 3, and the third barrel case 4 are provided with two abutment portions 11, 11, two abutment portions 23, 23, and two abutment portions 24, 24, and two abutment portions 36, 36, respectively.

The number of abutment portions 11, 23, 24, and 36 is further reduced in such a manner, thereby making it possible to further simplify the construction of the lens barrel 1.

When two abutment portions 11, 11, two abutment portions 23, 23, and two abutment portions 24, 24, and two abutment portions 36, 36 are provided, preferably, two abutment portions 11, 11, two abutment portions 23, 23, and two abutment portions 24, 24, and two abutment portions 36, 36 are provided so as to horizontally extend separately from each other in the front-back direction, that is, in the thickness direction of the first barrel case 2, the second barrel case 3, and the third barrel case 4. Two abutment portions 11, 11, two abutment portions 23, 23, and two abutment portions 24, 24, and two abutment portions 36, 36 are provided separately from each other in the front-back direction, the coupling state among the first barrel case 2, the second barrel case 3, and the third barrel case 4 can be stabilized after the simplification of the construction of the lens barrel 1 has been ensured.

It is noted that each of the numbers of abutment portions 11, 11, . . . , 23, 23, . . . , 24, 24, . . . , 36, 36, . . . may also be five or more.

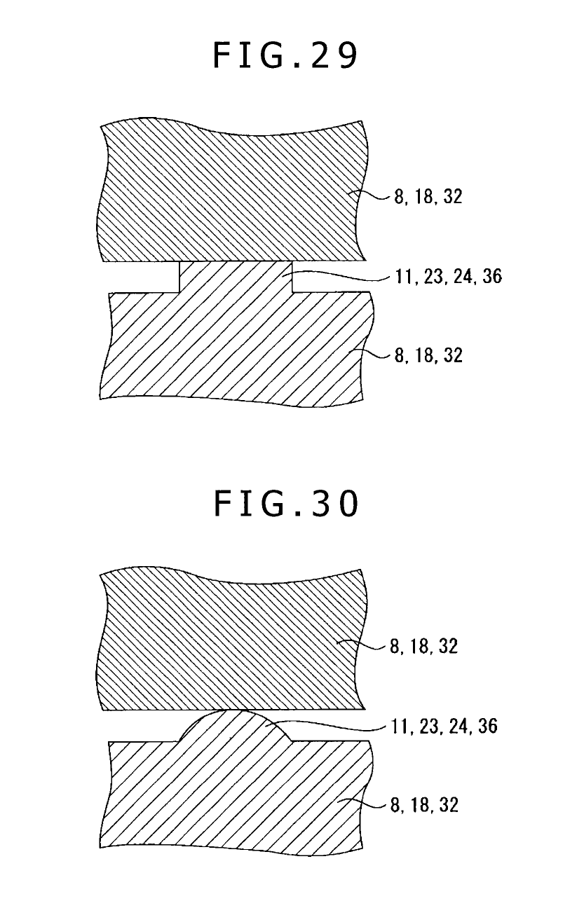

On the other hand, in the foregoing, there has been shown the case where the abutment portions 11, 23, 24, and 36 are formed in the protruding shapes, respectively. However, all it takes is that in the lens barrel 1, one of the abutment portions 11 and 23 which are made to abut against each other, and one of the abutment portions 24 and 36 which are made to abut against each other are formed in protruding shapes, respectively (refer to FIGS. 29 and 30).

In this case, for example, as shown in FIG. 29, the head end surfaces of one of the abutment portions 11 and 23, and one of the abutment portions 24 and 36 which are made to abut against each other may be formed in flat surface-like shapes, respectively. Alternatively, for example, as shown in FIG. 30, the external surfaces of one of the abutment portions 11 and 23, and one of the abutment portions 24 and 36 which are made to abut against each other may also be formed in curved surface-like shapes, respectively, that is, in shapes allowing point contact to be carried out.

Note that, in the foregoing, there has been shown the case where three barrel cases of the first barrel case 2, the second barrel case 3, and the third barrel case 4 are provided. However, the present disclosure is by no means limited to the case where three barrel cases are provided, and thus can also be applied to the case where two or four or more barrel cases are provided.

Outline of Construction of Imaging apparatus

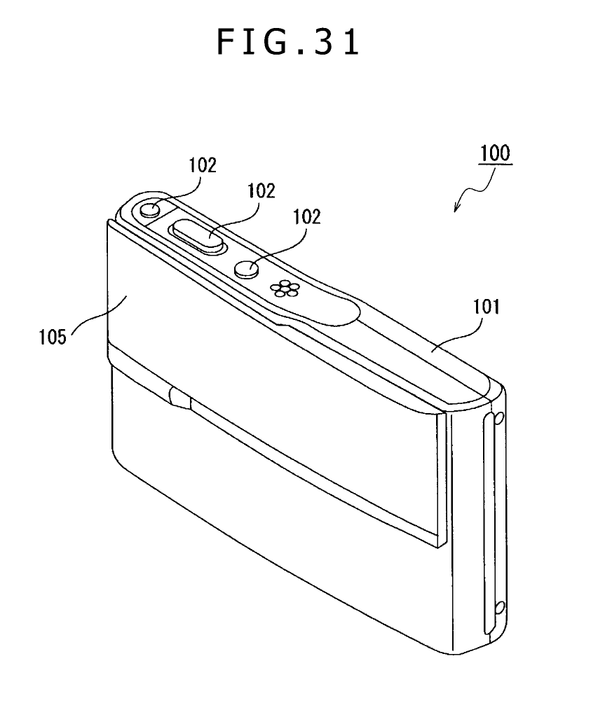

An imaging apparatus 100 according to a second embodiment of the present disclosure is constructed by disposing necessary portions inside and outside the chassis 101 (refer to FIGS. 31 to 33).

Various kinds of manipulation portions 102, 102, . . . are disposed on an upper surface of the chassis 101. With regard to the manipulation portions 102, 102, . . . , for example, a power source button, a shutter button, and the like are provided.

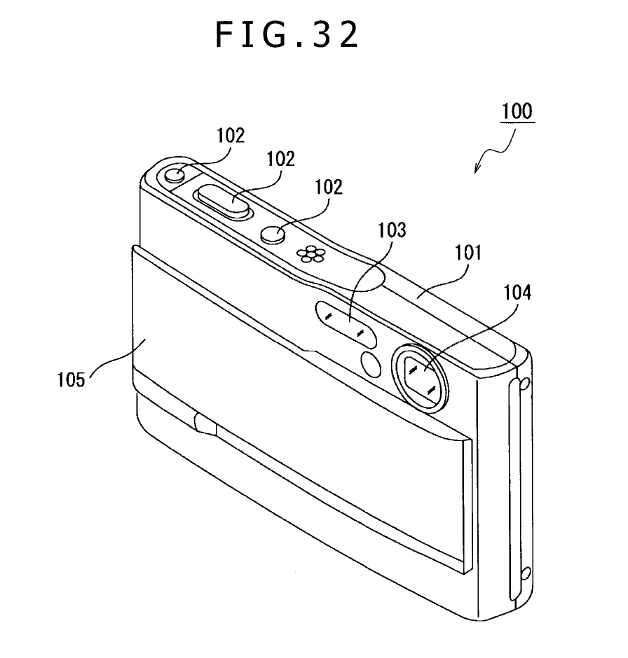

A flash window 103 and a lens window 104 are disposed in a front surface of the chassis 101. An opening-closing cover 105 is supported slidably in a vertical direction on the front surface of the chassis 101. Thus, the opening-closing cover 105 is slid in the vertical direction, thereby opening or closing both of the flash window 103 and the lens window 104 (refer to FIGS. 31 and 32).

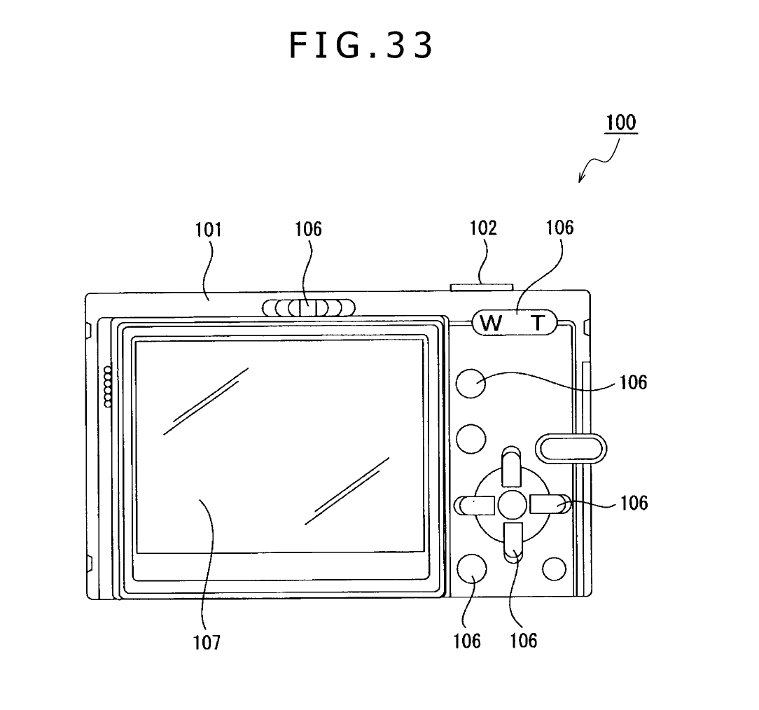

Various kinds of manipulation portions 106, 106, . . . are disposed on a back surface of the chassis 101 (refer to FIG. 33). With regard to the manipulation portions 106, 106, . . . , for example, a zooming switch, a mode switching knob, and the like are provided. A display device 107 is disposed on the back surface of the chassis 101.

### Configuration of Imaging Apparatus

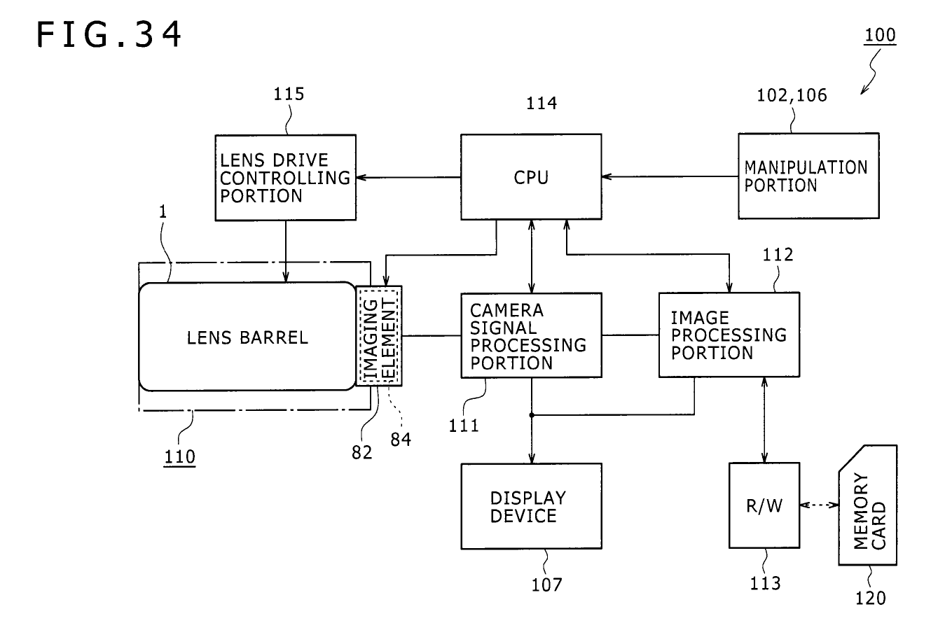

FIG. 34 is a block diagram showing a configuration of the digital still camera as the imaging apparatus according to the second embodiment of the present disclosure.

The imaging apparatus (digital still camera) 100 includes a camera block 110, a camera signal processing portion 111, and an image processing portion 112. In this case, the camera block 110 plays a role of an image capturing function. The camera signal processing portion 111 executes signal processing such as voltage-to-digital conversion for a signal based on an image obtained through the image capturing. Also, the image processing portion 112 executes recording/reproducing processing for the image signal. In addition, the imaging apparatus 100 includes a display device 107, a Read/Write (R/W) 113, a

Central Processing Unit (CPU) 114, manipulation portions 102 and 106, and a lens drive controlling portion 115. In this case, the display device 107 displays thereon an image or the like obtained through the image capturing. The R/W 113 carries out an operation for writing/reading out the image signal to/from a memory card 120. The CPU 114 controls the whole of the imaging apparatus 100. The manipulation portions 102 and 106 are composed of various kinds of switches with which a necessary manipulation(s) is (are) carried out by a user. Also, the lens drive controlling portion 115 controls drive for the lenses disposed in the camera block 110.

The camera block 110 is composed the lens barrel 1, and the imaging unit 82, for example, including an imaging element 84 such as a Charge Coupled Device (CCD) or a Complementary Metal-Oxide Semiconductor (CMOS).

The camera signal processing portion 111 executes various kinds of pieces of signal processing such as processing for converting an output signal (analog signal) from the imaging element 84 into a digital signal, noise removing processing, image-quality correcting processing, and processing for converting the digital signal into a luminance/color difference signal.

The image processing portion 112 executes compression coding/expansion decoding processing for the image signal based on a predetermined image data format, processing for converting a data specification such as a resolution, and the like.

The display device 107 has a function of displaying thereon various kinds of pieces of data such as data on a state of a manipulation carried out for the manipulation portions 102 and 106 by a user, and data on the image obtained through the image capturing.

The R/W 113 carries out an operation for writing the image data obtained through the coding by the image processing portion 112 to the memory card 120, and an operation for reading out the image data recorded in the memory card 120.

The CPU 114 functions as a control processing portion for controlling the circuit blocks 102, 106, 111, 112, 115, etc. provided in the imaging apparatus 100, and controls the circuit blocks 102, 106, 111, 112, 115, etc. in accordance with instruction input signals issued from the manipulation portions 102 and 106, and the like.

The manipulation portions 102 and 106, for example, are composed of a shutter button with which the shutter manipulation is carried out, a mode switching knob with which an operation mode is switched over to another one, and the like. Also, the manipulation portions 102 and 106 output the instruction input signal(s) corresponding to the manipulation(s) carried out by the user to the CPU 114.

The lens drive controlling portion 115 controls drive motors 45a, 60c, and the like for driving the lenses of the lens barrel 1 in accordance with a control signal outputted from the CPU 114.

The memory card 120, for example, is a semiconductor memory which is adapted to be detachably attached to a slot connected to the R/W 113.

Hereinafter, an operation of the imaging apparatus 100 will be described.

In a stand-by state of the photographing under the control made by the CPU 114, a signal of an image captured in the camera block 110 is outputted to the display device 107 through the camera signal processing portion 111, and is then displayed in the form of a camera-through image. In addition, when an instruction input signal for zooming has been inputted from the manipulation portions 102 and 106 to the CPU 114, the CPU 114 outputs the control signal to the lens drive controlling portion 115 and as a result, a predetermined lens(es) of the lens barrel 1 is (are) moved in accordance with the control made by the lens drive controlling portion 115.

When a shutter (not shown) of the camera block 110 has been operated in accordance with the instruction input signal issued from the manipulation portions 102 and 106, the signal of the image captured is outputted from the camera signal processing 111 to the image processing portion 112 to be subjected to the compression coding processing, thereby being converted into digital data complying with a predetermined data format. The resulting digital data obtained through the conversion is outputted to the R/W 113 to be written to the memory card 120.

When the manipulation portion (zoom knob) 106, for example, has been manipulated, the lens drive controlling portion 115 moves the zoom movement frame 50 of the lens barrel 1 in accordance with the control signal from the CPU 114, thereby carrying out the zooming.

When the manipulation portion (shutter button) 102, for example, either has been pressed halfway or has been pressed fully for recording (photographing), the lens drive controlling portion 115 moves the focus movement frame 62 of the lens barrel 1 in accordance with the control signal from the CPU 114, thereby carrying out the focusing.

When the image data recorded in the memory card 120 is desired to be reproduced, predetermined image data is read out from the memory card 120 by the R/W 113 in accordance with the manipulation carried out for the manipulation portions 102 and 106, and is then subjected to the expansion decoding processing by the image processing portion 112. After that, the reproduced image signal is outputted to the display device 107 to be displayed thereon in the form of a regeneration picture.

Note that, in the second embodiment of the present disclosure, there has been shown the case where the imaging apparatus is applied to the digital still camera. However, the scope of application of the imaging apparatus is by no means limited to the digital still camera, and thus the imaging apparatus, for example, can also be generally applied as a camera portion of a digital input/output apparatus such as a digital video camera, a mobile phone having a camera incorporated therein, or a Personal Digital Assistant (PDA) having a camera incorporated therein.

### CONCLUSION

As described hereinabove, in the lens barrel 1, plural abutment portions 11, 23, 24, and 36 are provided which are made to abut against each other in the state in which the first barrel case 2, the second barrel case 3, and the third barrel case 4 are coupled to the holding frame portions 8, 18, and 32 of the first barrel case 2, the second barrel case 3, and the third barrel case 4, respectively.

Therefore, it is possible to prevent the generation of the deformation and the strain in the state in which the first barrel case 2, the second barrel case 3, and the third barrel case 4 are coupled to one another. Thus, it is also possible to prevent the generation of the dispersion of the optical resolution performances among the products in the same product.

In particular, in the lens barrel 1 utilizing the folded optical system as described above, the positional relationship between the first lens group 90 as the fixed group disposed in the first barrel case 2, and the third lens group 92 as the fixed group disposed in the second barrel case 3 largely contributes to the optical performance.

Therefore, the generation of the deformation and the strain in the state in which the first barrel case 2, the second barrel case 3, and the third barrel case 4 are coupled to one another is prevented, whereby in the type of the folded optical system like the lens barrel 1, it is possible to largely enhance the optical performance.

In addition, the abutment portions 11, 23, 24, and 36 are formed in the shapes protruding to the sides each receiving the abutment. Therefore, the satisfactory contact states between the abutment portions 11 and 23, and between the abutment portions 24 and 36 are ensured, and thus it is possible to further prevent the generation of the deformation and the strain in the lens barrel 1.

In addition, the head end surfaces of the abutment portions 11, 23, 24, and 36 are formed as the flat surface-like abutment surfaces 11a, 23a, 24a, and 36a. Therefore, the abutment portions 11, 23, 24, and 36 are made to come in surface-contact with each other, and thus it is possible to more effectively prevent the generation of the deformation and the strain in the lens barrel 1.

In addition thereto, the plural abutment portions 11, 11, . . . , the plural abutment portions 23, 23, . . . and the plural abutment portions 24, 24, . . . , and the plural abutment portions 36, 36, . . . are provided in the holding frame portions 8, 18, and 32, respectively. Therefore, the stable coupling state among the first barrel case 2, the second barrel case 3, and the third barrel case 4 is ensured, and thus it is possible to further prevent the generation of the deformation and the strain in the lens barrel 1.

### Constitutions of the Present Disclosure

The present disclosure can also adopt the following constitutions.

(1) A lens barrel including: plural barrel cases having holding frame portions holding optical members, respectively, and coupled to one another in a predetermined direction; and plural abutment portions made to abut against one another in a state in which the plural barrel cases are coupled to the holding frame portions, respectively, in which the abutment portion of at least one of the plural barrel cases coupled to one another is formed in a shape protruding to the abutment portion side of the other of the plural barrel cases coupled to one another.

(2) The lens barrel described in the paragraph (1), in which the abutment portions which are made to abut against each other are formed in shapes protruding to sides of the abutment portions each receiving the abutment.

(3) The lens barrel described in the paragraph (1) or (2), in which at least three abutment portions are provided in the holding frame portions.

(4) The lens barrel described in any one of the paragraphs (1) to (3), in which at least three barrel cases are coupled to one another in the predetermined direction, and the abutment portions provided in the barrel cases, respectively, and made to abut against one another are provided in positions, respectively, arranged on one straight lines in a coupling direction of the barrel cases.

(5) The lens barrel described in any one of the paragraphs (1) to (4), in which plane-like abutment surfaces which are made to come in surface-contact with one another are formed in the abutment portions, respectively.

(6) The lens barrel described in any one of the paragraphs (1) to (5), in which each of portions of the holding frame portions in which the abutment portions are provided is provided as a thick portion which is thicker in a direction orthogonal to the coupling direction of the barrel cases than any of other portions of the holding frame portion.

(7) The lens barrel described in any one of the paragraphs (1) to (6), in which screw fastening portions in which the barrel cases coupled to one another are fastened by using mounting screws are provided in outer peripheral portions of the holding frame portion of the barrel case.

(8) The lens barrel described in the paragraph (7), in which in the state in which the barrel cases are coupled to one another, the screw-fastening portions are held in a non-contact state.

(9) The lens barrel described in any one of the paragraphs (1) to (8), in which a falling prevention protruding portion which is provided inside a chassis of an imaging apparatus, which is adapted to contact an inner surface of the chassis of the imaging apparatus, and which protrudes to the inner surface side of the chassis is provided in the barrel case.

(10) The lens barrel described in the paragraph (9), in which the falling prevention protruding portion is located so as to face a reception protruding portion which is provided in the inner surface of the chassis so as to protrude to a side of the falling prevention protruding portion.

(11) The lens barrel described in the paragraph (9) or (10), in which an inclination prevention protruding portion is provided in a surface on a side opposite to a surface on which the falling prevention protruding portion of the barrel case is provided.

(12) The lens barrel described in the paragraph (11), in which the falling prevention protruding portion and the inclination prevention protruding portion are provided in positions, respectively, arranged on one straight line in a direction orthogonal to the coupling direction.

(13) The lens barrel described in any one of the paragraphs (9) to (12), in which three barrel cases are coupled to one another, and an interval between the falling prevention protruding portion of the barrel case located at a center, and the inner surface of the chassis is made smaller than that between the falling prevention protruding portion of each of other barrel cases, and the inner surface of the chassis.

(14) The lens barrel described in any one of the paragraphs (11) to (13), in which three barrel cases are coupled to one another, and an interval between the inclination prevention protruding portion of the barrel case located at the center, and the inner surface of the chassis is made smaller than that between the inclination prevention protruding portion of each of other barrel cases, and the inner surface of the chassis.

(15) An imaging apparatus including: a chassis; and a lens barrel disposed inside the chassis, having a predetermined optical member, and capturing an optical image through the predetermined optical member, the lens barrel including: plural barrel cases having holding frame portions holding optical members, respectively, and coupled to one another in a predetermined direction; and plural abutment portions made to abut against one another in a state in which the plural barrel cases are coupled to the holding frame portions, in which the abutment portion of at least one of the plural barrel cases coupled to one another is formed in a shape protruding to the abutment portion side of the other of the plural barrel cases coupled to one another.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-187927 filed in the Japan Patent Office on Aug. 30, 2011, the entire content of which is hereby incorporated by reference.

What is claimed is:

1. A lens barrel, comprising:
plural barrel cases having holding frame portions holding optical members, respectively, and coupled to one another in a predetermined direction; and
plural abutment portions made to abut against one another in a state in which the plural barrel cases are coupled to the holding frame portions, respectively,
wherein the abutment portion of at least one of the plural barrel cases coupled to one another is formed in a shape protruding to the abutment portion side of the other of the plural barrel cases coupled to one another.

2. The lens barrel according to claim 1, wherein the abutment portions which are made to abut against each other are formed in shapes protruding to sides of the abutment portions each receiving the abutment.

3. The lens barrel according to claim 1, wherein at least three abutment portions are provided in the holding frame portions.

4. The lens barrel according to claim 1, wherein at least three barrel cases are coupled to one another in the predetermined direction, and the abutment portions provided in the barrel cases, respectively, and made to abut against one another are provided in positions, respectively, arranged on one straight lines in a coupling direction of the barrel cases.

5. The lens barrel according to claim 1, wherein plane-like abutment surfaces which are made to come in surface-contact with one another are formed in the abutment portions, respectively.

6. The lens barrel according to claim 1, wherein each of portions of the holding frame portions in which the abutment portions are provided is provided as a thick portion which is thicker in a direction orthogonal to the coupling direction of the barrel cases than any of other portions of the holding frame portion.

7. The lens barrel according to claim 1, wherein screw fastening portions in which the barrel cases coupled to one another are fastened by using mounting screws are provided in outer peripheral portions of the holding frame portion of the barrel case.

8. The lens barrel according to claim 7, wherein in the state in which the barrel cases are coupled to one another, the screw-fastening portions are held in a non-contact state.

9. The lens barrel according to claim 1, wherein a falling prevention protruding portion which is provided inside a chassis of an imaging apparatus, which is adapted to contact an inner surface of the chassis of the imaging apparatus, and which protrudes to the inner surface side of the chassis is provided in the barrel case.

10. The lens barrel according to claim 9, wherein the falling prevention protruding portion is located so as to face a reception protruding portion which is provided in the inner surface of the chassis so as to protrude to a side of the falling prevention protruding portion.

11. The lens barrel according to claim 9, wherein an inclination prevention protruding portion is provided in a surface on a side opposite to a surface on which the falling prevention protruding portion of the barrel case is provided.

12. The lens barrel according to claim 11, wherein the falling prevention protruding portion and the inclination prevention protruding portion are provided in positions, respectively, arranged on one straight line in a direction orthogonal to the coupling direction.

13. The lens barrel according to claim 9, wherein three barrel cases are coupled to one another, and an interval between the falling prevention protruding portion of the barrel case located at a center, and the inner surface of the chassis is made smaller than that between the falling prevention protruding portion of each of other barrel cases, and the inner surface of the chassis.

14. The lens barrel according to claim 11, wherein three barrel cases are coupled to one another, and an interval between the inclination prevention protruding portion of the barrel case located at the center, and the inner surface of the chassis is made smaller than that between the inclination prevention protruding portion of each of other barrel cases, and the inner surface of the chassis.

15. An imaging apparatus, comprising:
a chassis; and
a lens barrel disposed inside the chassis, having a predetermined optical member, and capturing an optical image through the predetermined optical member, said lens barrel including
plural barrel cases having holding frame portions holding optical members, respectively, and coupled to one another in a predetermined direction, and
plural abutment portions made to abut against one another in a state in which the plural barrel cases are coupled to the holding frame portions, respectively,
wherein the abutment portion of at least one of the plural barrel cases coupled to one another is formed in a shape protruding to the abutment portion side of the other of the plural barrel cases coupled to one another.
